(19) United States
(12) Patent Application Publication
(10) Pub. No.: US 2025/0216874 A1
(43) Pub. Date: Jul. 3, 2025

(54) VOLTAGE VARIATION SUPPRESSION USING PSRR BOOST IN LINEAR REGULATORS

(71) Applicant: MELLANOX TECHNOLOGIES, LTD., Yokneam (IL)

(72) Inventor: Alajdin Rustemi, Copenhagen (DK)

(21) Appl. No.: 18/403,208

(22) Filed: Jan. 3, 2024

(51) Int. Cl. G05F 1/565; G05F 1/575; G06F 3/01

(52) U.S. Cl. CPC G05F 1/565; G05F 1/575; G06F 3/011

(57) ABSTRACT

Approaches disclosed herein provide for increasing the Power Supply Rejection Ratio (PSRR) of a linear regulator to reduce noise in voltage from a power source. In at least one embodiment, at least a portion of a voltage to be output provided from the linear regulator is identified to include noise and is received to a correction circuit. The correction circuit processes the received noise to reverse the polarity and add gain. The processed noise is provided back to at least a portion of the voltage and can be used to suppress the noise of the voltage as the PSRR of the linear regulator increases.

### TECHNICAL FIELD

At least one embodiment pertains to linear regulators, including systems and methods for operating those linear regulators. In at least one embodiment, such a linear regulator can be utilized with one or more noise correction features.

### BACKGROUND

A limited number of external supply voltages from power supplies or voltage sources can be directly provided to microchips. External supply voltage can contain noise or ripples from external components, as well as signals, switches, or other elements of the chip. Chips, including high speed chips, can be sensitive to the voltage noise, which should not be present in the voltage supplied to the chip from a linear regulator. Linear regulators within or associated with the chip can receive the supply voltages, such as from power sources, and process the supply voltages to output a regulated voltage to other systems. Low drop-out (LDO) linear regulators may regulate an supply voltage powered from a higher voltage source and provide a well-controlled and low noise output voltage. The noise or ripple of the externally supplied input voltage may be present in different frequencies, such as low frequencies, middle frequencies, and very high frequencies. LDO linear regulators may be limited in the frequencies that can be effectively regulated, such as the middle frequencies. Dual loop flipped voltage follower positive-channel Metal-oxide Semiconductor (PMOS) topology has been used to improve the Power Supply Rejection Ratio (PSRR) of LDO linear regulators, but the dual loops experience inefficient interactions, and the effectiveness can be limited, especially for middle frequencies of the externally supplied input voltage. The PSRR can be a crucial parameter for LDO linear regulators, with effective PSRR needed across a large frequency band. For an LDO to achieve effective PSRR, the error amplifier may need both high-gain and high-bandwidth, which may be challenging with LDOs of high-speed circuits.

### BRIEF DESCRIPTION OF THE DRAWINGS

FIG. 1 illustrates a computing system associated with linear regulator systems, according to at least one embodiment.

FIG. 2A illustrates an exemplary linear regulator system, according to at least one embodiment;

FIG. 2B illustrates PSRR boost loop features associated with linear regulator systems using noise correction features, according to at least one embodiment;

FIG. 3A illustrates waveform features associated with linear regulator using noise correction features, according to at least one embodiment;

FIG. 3B illustrates waveform features associated with linear regulator using noise correction features, according to at least one embodiment;

FIG. 4 illustrates waveform features associated with linear regulator using noise correction features, according to at least one embodiment;

FIG. 5 illustrates a method associated with a linear regulator system, according to at least one embodiment;

FIG. 6 illustrates a method associated with a linear regulator system, according to at least one embodiment;

FIG. 7 illustrates a method associated with a linear regulator system, according to at least one embodiment;

FIG. 8 illustrates an example data center system, according to at least one embodiment;

FIG. 9 is a block diagram illustrating a computer system, according to at least one embodiment;

FIG. 10 is a block diagram illustrating a computer system, according to at least one embodiment;

FIG. 11 illustrates a computer system, according to at least one embodiment;

FIG. 12 illustrates a computer system, according to at least one embodiment;

FIG. 13 illustrates exemplary integrated circuits and associated graphics processors, according to at least one embodiment;

FIGS. 14A, 14B illustrate exemplary integrated circuits and associated graphics processors, according to at least one embodiment;

FIGS. 15A, 15B illustrate additional exemplary graphics processor logic according to at least one embodiment;

FIG. 16 illustrates a computer system, according to at least one embodiment;

FIG. 17A illustrates a parallel processor, according to at least one embodiment;

FIG. 17B illustrates a partition unit, according to at least one embodiment;

FIG. 17C illustrates a processing cluster, according to at least one embodiment;

FIG. 17D illustrates a graphics multiprocessor, according to at least one embodiment;

FIG. 18 illustrates a multi-graphics processing unit (GPU) system, according to at least one embodiment;

FIG. 19 illustrates a graphics processor, according to at least one embodiment; and

FIG. 20 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments provide for the reduction of variations in voltages provided from external sources. In particular, various embodiments can perform isolation and correction of ripples in voltage mid-frequency regions, such as by improving the PSRR response in LDO linear regulators for high-speed circuits, such as for voltages from an external power source. In an embodiment, the LDO linear regulator may include a main loop to set the DC regulated voltage, and may include a N-channel Metal-oxide Semiconductor (NMOS) pass device configured as a source follower to cancel out residual ripples at the output regulated voltage. The NMOS pass device may be in connection with a suppression element, such as a PSRR boost loop, that surrounds a portion of the NMOS pass device to receive and cancel out residual ripples of mid-range, high, and very high frequencies. The PSRR boost loop can sense supply ripple at the regulated voltage, add gain to the ripple, and invert the ripple polarity. The inverted, or opposite polarity ripple can then be applied to the portion of the NMOS pass device which cancels out the residual ripple at the DC regulated voltage. The linear regulator may include an error amplifier, gate capacitor, output capacitor, isolating resistor, and other circuit elements to improve the PSRR response for high and low frequencies, as well as supplement the operation of the PSRR boost loop. The PSRR boost loop can include a high-pass filter at the input and the output, an Operational Transconductance Amplifier (OTA), as well as three cascaded GM-GM inverter stages to add gain, improve driving capability, and reverse the polarity of the ripple. Separating the PSRR boost loop from the main loop with the NMOS pass device can allow the PSRR boost loop to operate at high speed, isolate the main loop from the PSRR boost loop to maintain stability, and ignore DC operating points when correcting the ripple by using AC coupling. In certain embodiments, the use of the NMOS pass device and PSRR boost loop may improve the PSRR response in at least mid-range frequencies, the worst performing frequency region.

Variations of this and other such functionality can be used as well within the scope of the various embodiments as would be apparent to one of ordinary skill in the art in light of the teachings and suggestions contained herein.

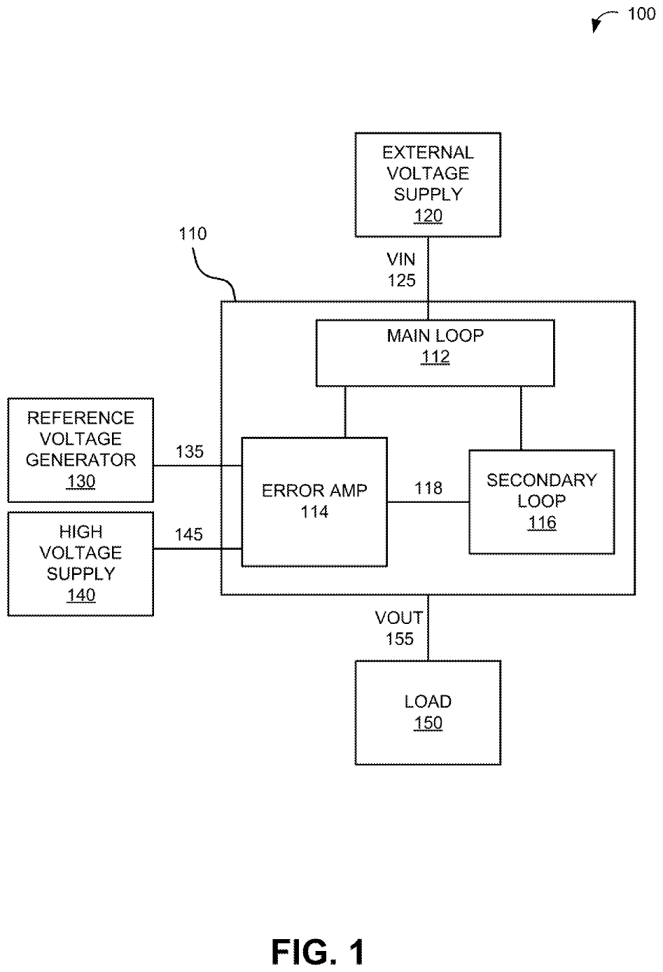

In at least one embodiment, an computing system 100 can be utilized as illustrated in FIG. 1, including a computing environment incorporating linear regulator system subject to improvements described herein. In at least one embodiment, a computing system 100 may include a linear regulator 110, such as an LDO linear regulator. In an embodiment, the linear regulator 110 may be part of a high-speed power management integrated circuit. The linear regulator 110 may include one or more elements, such as a primary loop 112, an error amplifier 114, a secondary loop 116, and the like. The primary loop 112 may include one or more elements configured to receive and process the an input voltage 125 provided from an external voltage supply 120. The external voltage supply 120 may provide the input voltage 125 that includes detrimental variations, such as ripples, noise, and the like. The linear regulator 110 may provide an output voltage 155 to a load 150. The load 150 may be sensitive to voltage variations. In an embodiment, the load 150 may comprise one or more components, such as circuits, microchips, processor, and the like. In an embodiment, the primary loop 112 may be used to correct DC frequency variations of the input voltage 125.

An error amplifier 114 of the primary loop 112 may be used to provide a regulated voltage 118 to the primary loop 112 and the secondary loop 116. In an embodiment, a portion of the regulated voltage 118 is provided to the primary loop 110 and the remaining portion of the regulated voltage 118 is provided to the secondary loop 116. The error amplifier 114 may receive a reference voltage 135 from a reference voltage generator 130 to indicate the required power level of the regulated voltage 118. The error amplifier 114 may receive the regulated voltage 118 from a feedback loop. The error amplifier 114 may equalize the reference voltage 135 and the regulated voltage 118. The error amplifier 114 may be supplied a high voltage 145 from a high voltage supply 140 to maintain the power level of the regulated voltage 118. In an embodiment, the error amplifier 114 may be used to correct DC frequency variations of the input voltage 125.

A secondary loop 116 of the linear regulator 110 may include one or more elements configured to sense and process variations of the regulated voltage 118 above DC frequencies. The error amplifier 114 may provide the needed voltage level to agate of a pass device NMOS source follower, which can then provide the regulated voltage 118. The secondary loop 116 may be used provide a corrective variation to the regulated voltage 118, reducing or removing the variation of the regulated voltage 118 above DC frequencies. In an embodiment, the secondary loop 116 may be used to correct variations of the input voltage 125 above DC frequencies. The corrected regulated voltage 118 may be provided to the load 150 as output voltage 155.

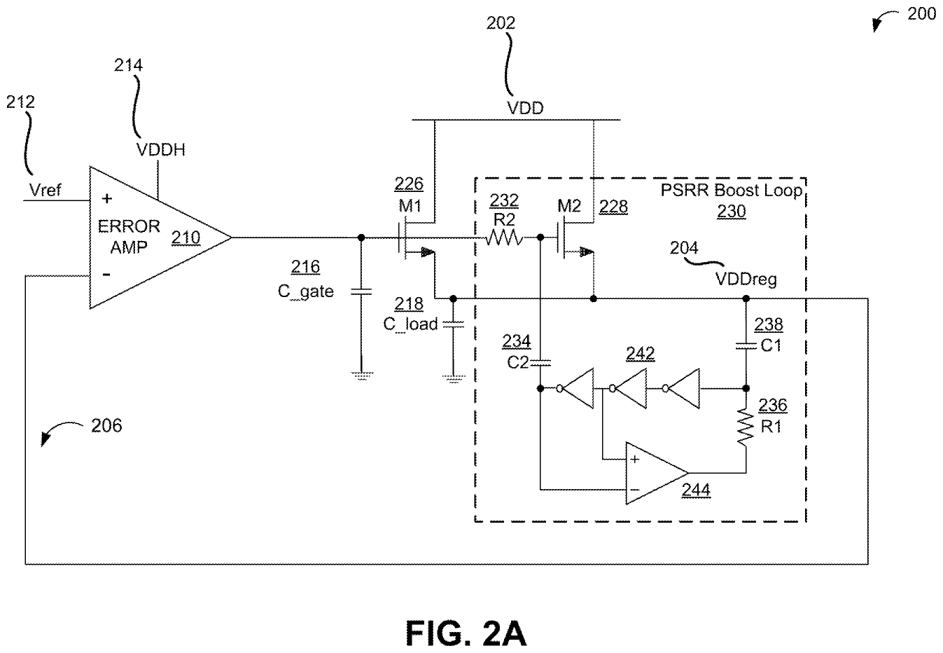

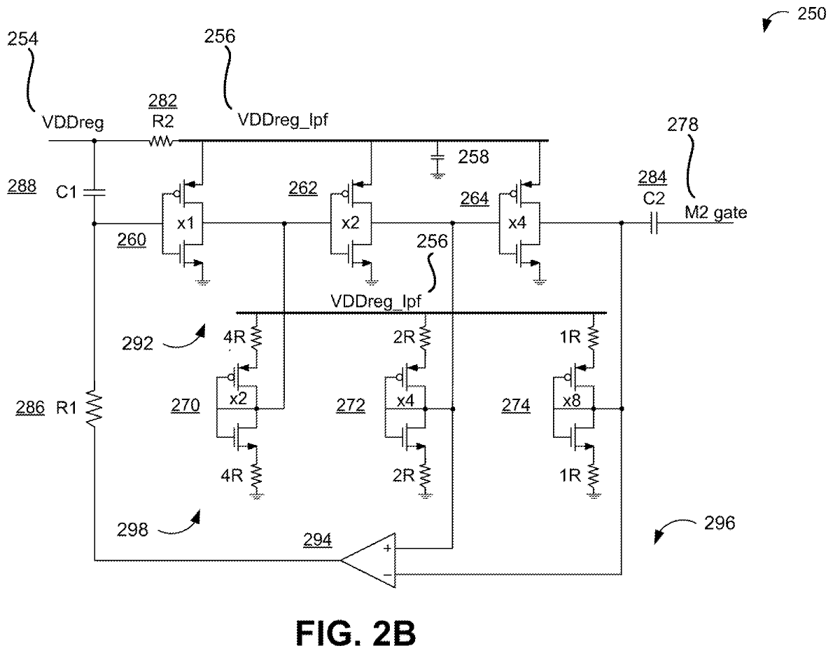

In at least one embodiment, an exemplary linear regulator 200 can be utilized as illustrated in FIG. 2A, which has a PSRR boosting system subject to improvements described herein. In at least one embodiment, a linear regulator 200 may receive a supply voltage 202 VDD from a supply voltage source, such as an external power supply. The linear regulator 200 may include a main loop to suppress low frequencies using an error amplifier 210 with a positive input and a negative input. The positive input of the error amplifier 210 may receive a reference voltage Vref 212 and the negative input of the error amplifier 210 may receive a regulated voltage VDDreg 204 processed from the supply voltage 202. The error amplifier 210 may receive a high-power supply voltage VDDH 214 to maintain the voltage level of the signal output from the error amplifier 210.

The error amplifier 210 may be used to amplify noise present in the signal of the regulated voltage VDDreg 204, such as residual noise of the supply voltage 202. When processing the voltages from the positive input and the negative input, the error amplifier 210 equalizes the voltages. The signal output from the error amplifier 210 may control two NMOS devices, a gate transistor M1 226 that may consist of about 90% of the total pass device size and an output transistor M2 228 that may consist of about 10% of the total pass device size, which combined may provide all of the output current. In some embodiments, the NMOS devices may be configured as source followers. By controlling the NMOS devices, the error amplifier 210 can also control the source of the NMOS pass device where the output regulated voltage VDDreg 204 may increase or decrease. That output regulated voltage VDDreg 204 may then go back in a feedback loop 206 to the error amplifier 210, such as to the negative input. The reference voltage Vref 212 may be provided to the error amplifier 210 with the voltage value to be output from the linear regulator 200. In an embodiment, the error amplifier 210 may provide the needed voltage output to the gate of the NMOS devices such that the regulated voltage VDDreg 204 node comes as close as possible to equal to the reference voltage Vref 212 node.

The circuit loop including the NMOS pass devices, the gate transistor M1 226, and the output transistor M2 228 may be stable, and may have dominant poles, non-dominant poles, and phase shifting. In some embodiment, the loop may include a PMOS pass devices as well. A capacitor C_gate 216 at the gate of the NMOS may improve the stability of the circuit loop. In some embodiments, the capacitor C_gate 216 may limit bandwidth of the loop, limiting the speed of the loop. In an example, the loop with gain bandwidth of about one megahertz may compensate up to about one megahertz frequency, and above about one megahertz frequency the loop cannot compensate. Accordingly, by using the capacitor C_gate 216 the loop may lose all gain for frequencies above about one megahertz. For example, in a loop with a gain bandwidth of about one megahertz, a supply ripple at frequencies below about one megahertz, such as a 100 kHz, may also be at the error amplifier 210 input. Since the reference voltage Vref 212 may be assumed as stable, the ripple may be present. The error amplifier 210 together with the low frequency loop of the LDO linear regulator 200 may compensate for the ripple, or other noise of lower frequencies present in the output regulated voltage VDDreg 204.

The linear regulator 200 may compensate for very high frequencies, such as frequencies above two gigahertz, five gigahertz, 50 gigahertz, 100 gigahertz, or other frequencies or frequency ranges. The ripple or noise at very high frequencies may be suppressed using the output capacitor C_load 218 at the output regulated voltage VDDreg 204. A very high frequency ripple in the supply voltage 202 may be coupled at the output regulated voltage VDDreg 204. At very high frequencies the output capacitor C_load 218 may act as a very low impedance component, where the output capacitor C_load 218 may normalize or take in the ripple, and maximally suppress the ripple at the output regulated voltage VDDreg 204. For example, at very low frequencies, such as around 100 hertz up to 100 kilohertz, or other low frequencies, the output regulated voltage VDDreg 204 may have about 55 dbs of PSRR, because the frequencies may be within the speed of the low frequency compensating loop. At very high frequencies, for example higher than two gigahertz, 10 gigahertz, or another very high frequency, the output capacitor C_load 218 can improve the PSRR.

Improving the PSRR of the linear regulator 200 in the middle part of the frequency range may affect a range of frequencies, which may change depending on the specific linear regulator, and may range from about one megahertz or five megahertz to about one gigahertz or five gigahertz, or another frequency range, or between the low frequency range and high frequency range of the linear regulator. In an embodiment, the middle part of the frequency range may range from about above DC frequencies to about 1 gigahertz or 5 gigahertz. Compensating for supply ripple coupling to the output regulated voltage VDDreg 204 may be more difficult at the middle frequencies because the main regulator loop that compensates low frequencies and the output capacitor C_load 218 that compensates for high frequencies may not be effective. Therefore, a PSRR boost technique using a PSRR boost loop 230 may improve the PSRR at the middle part of the frequency spectrum. Topology of the PSRR boost loop 230, or noise correction loop, may provide improved PSRR and noise correction compared to previous LDO topology.

The PSRR boost loop 230 may include one or more circuit elements or electrical components, such as the NMOS pass device with the gate transistor M1 226 and the output transistor M2 228, which alone may provide improved PSRR compared to a PMOS. Additionally, the PSRR boost loop 230 may include other elements or components, which divide the total of the pass device. For example, the total pass device may be divided into two sections, with the gate transistor M1 226 section responsible for some the current, such as about 90% of the past device current, and with the output transistor M2 228 section responsible for some of the current, such as about ten percent of the pass device current. While pass devices may provide a large amount of current or all the current needed to be synchronized from the linear regulator 200, pass devices may handle ripples that could come to the output of the linear regulator 200. In an embodiment, the current may be divided into one frequency spectrum portion at gate transistor M1 226 for the total pass device as part of the main loop 206 and another frequency spectrum portion above DC frequencies with the output transistor M2 228 as part of the PSRR boost loop 230. The output voltage of the error amplifier 210 biases both the gate transistor M1 226 and the output transistor M2 228. In an embodiment, at low frequencies or very low frequencies the gate transistor M1 226 and the output transistor M2 228 may act as a single device. Resistor R2 232 may also be used desired high pass filter. The resistance of the resistor R2 232 may depend on the desired high pass filter cutoff frequency and may be around or more than about 100 kiloohms to 200 kiloohms of resistance, or another suitable resistance for the linear regulator 200. At higher frequencies, the current may be controlled by the high speed PSRR boost loop 230 which may improve power supply rejection.

The PSRR boost loop 230 may include at least two high pass filters. One of the high pass filters may include a resistor R1 236 and a capacitor C1 238. The second high pass filter may include a resistor R2 232 and a capacitor C2 234. The resistor R1 236 and the capacitor C1 238 may act as the high pass filter at the input of PSRR boost loop 230 and the resistor R2 232 and the capacitor C2 234 may act as the high pass filter at the output of the PSRR boost loop 230. In an embodiment, between the two high pass filters the PSRR boost circuit 230 may include three stages 242 of high-speed amplifying. For example, the stages 242 may be GM-GM stages, with an inverter cascaded by a shorted inverter with degeneration resistors. The stages 242 may scale up in size. The stages 242 may add gain to the voltage throughout and may correct the polarity at the gate of the output transistor M2 228. The PSRR boost loop 230 may also include a slow loop with a operational transconductance amplifier (OTA) 244 at the bottom. The OTA 244 may operate in the low or very low part of the frequency spectrum of the linear regulator 200. The slow loop and the OTA 244 may ensure correct DC biasing, or operating point, of the GM-GM inverter amplifiers 242 to provide the best combination of maximum gain and maximum bandwidth. In an embodiment, the PSRR boost loop 230 may combining a NMOS pass device topology with a fast loop around a fraction of the NMOS pass device. The fast loop may sense a supply ripple at a output regulated voltage, add gain to the sensed ripple, and then apply the ripple with inverted, or opposite, polarity to the fraction of the pass device to correct for the supply ripple.

The PSRR boost loop 230 may identify, or sense ripple at the regulated voltage VDDreg 204 node of the PSRR boost loop 230. The identified ripple may be received into the PSRR boost loop 230 and pass through the high pass filter of the resistor R1 236 and the capacitor C1 238. The sensed ripple may then be provided to the three high speed inverter amps 242. The ripple may then pass through the three GM-GM stages 242. With an odd number of the GM-GM stages 242, the polarity of the ripple may be inverted at the output of the third stage from the original polarity. With the inverted polarity at the output gate the ripple may go through the second high pass filter through the resistor R2 232 and the capacitor C2 234. The output ripple then may be inverted in polarity from ripple frequency at regulated voltage VDDreg 204 node and with slightly higher gain at the gate of the output transistor M2 228. With the NMOS pass device connected in a source follower configuration, the source of the NMOS may follow the gate. For example, if a ripple goes lower than the desired voltage, then the output transistor M2 228 gate may have inverted polarity, going up but with more gain. The output transistor M2 228 source may compensate for that by going up and then compensate for the ripple going down at the output transistor M2 228.

The PSRR boost loop 230 may be very high speed in order to improve the PSRR of the middle frequency range, since improving the PSRR of the middle frequency range has be difficult for circuit designers. The PSRR boost loop 230 may not directly interact with or destabilize main loop. The PSRR boost loop 230 may be connected to the main loop or main circuit through the two high pass filters and may control middle frequencies ripples in only a portion, such as 10%, of the whole pass device. Therefore, unlike previous linear regulator systems, interference between the two loops may be minimized. The PSRR boost loop 230 may connect with the main loop through AC coupling. The two high pass may not require aligning the DC operating point of the compensation device 228 and the three GM-GM inverter amplifiers 242 of the high-speed path. For example, the three GM-GM high speed inverter amplifiers 242 may have their own voltage level or operating points where they operate best in terms of speed and gain, and the voltage level or operating point at the gate of the output transistor M2 228 of the NMOS pass device may be separate or different, and they may not need to be aligned. Each of them can separated in terms of DC coupling because the loop may be operated with AC coupling throughout the high pass filters. The PSRR boost loop 230 may not compensate or fix ripples at very low frequencies or frequencies close to DC, because the main loop may correct at those frequencies.

The NMOS pass device topology of the PSRR boost loop 230 may improve the PSRR of the linear regulator 200 but may experience dropout across the NMOS pass device. The NMOS pass device may need to have a gate to source voltage, or an overdrive voltage, and then maintain the voltage in the active region of the NMOS pass device, which may cause drop-off. Having the same supply voltage level both for the NMOS pass device and for the error amplifier 210 may cause difficulties when providing an output regulated voltage VDDreg 204 close to the main supply voltage of the NMOS pass devices. For example, to provide 1.25 volts at the output with 1.5 volts of main supply on top, there may only be 250 millivolts of drop across the NMOS pass devices. A PMOS may only needs to go lower at the gate and related pieces. However, having the NMOS connected in a source follower configuration, with 1.5 volts and providing voltage, such as 1.25 volts with only 250 millivolts of drop, a higher gate voltage than the main voltage supply may be needed for the NMOS pass devices.

There may be two different supplies, a supply voltage 202 equal to 1.5 volts for the NMOS pass device and a high-power supply voltage VDDH 214 of 3.3 volts, where the 3.3 volts high-power supply voltage VDDH 214 may be only for the error amplifier 210 and the 1.5 volts supply voltage 202 may be for the NMOS high pass devices. Power consumption for microchip may require be careful design. The largest amount of current may be provided by the 1.5 volts supply 202 to minimize current drawn from the high-power supply voltage VDDH 214, the 3.3 volts supply. Only the error amplifier 210 may be supplied by the 3.3 volt high-power supply voltage VDDH 214 because the error amplifier 210 has limited and mostly constant current consumption. The main power consumption comes at the output of the linear regulator 200 where to supply other different circuits, provided by the lower 1.5 volts supply 202.

In an embodiment, the PSRR boost loop 230 may be associated of one or more systems, such as a microchip, circuits, graphics processing unit chips (GPUs), serializer/de-serializer (SerDes) units, chips with internal power management circuits, power management integrated circuits, or other suitable systems. In an embodiment, the PSRR boost loop 230 may be part of one or more circuits within a system. In an embodiment, the PSRR boost loop 230 may be part of or associated with, for example and without limitation, a datacenter, computer system, processor, and the like.

In at least one embodiment, PSRR boost loop features 250 can be utilized as illustrated in FIG. 2B, with circuit elements, or electrical components, and configurations subject to improvements described herein. In at least one embodiment, the PSRR boost loop features 250 may include an output regulated voltage supply VDDreg 254 of the linear regulator, a resistor R1 286 and a capacitor C1 288 at the input, and a capacitor C2 284 and a resistor, not shown, connected to an output transistor M2 278 gate. The capacitor C2 284 may be connected at the output transistor M2 278 gate at one side and the other side the resistor may be connected to create the high pass field.

The PSRR boost loop features 250 may include the first high pass filter including the resistor R1 286 and the capacitor C1 288 to first receive a ripple of the output regulated voltage VDDreg 254, and then three inverter amplifier stages 292 may be provided the output signal from the first high pass filter. Each of the stages 292 may be a GM-GM stage with the components or inverters supplied by the output regulated voltage VDDreg 254 at the output of the linear regulator after passing through a low pass filter resistor 282, as a low pass filter supply voltage VDDreg_lpf 256. After passing through the resistor R1 286 and the capacitor C1 288 of the first high pass filter, the ripple at output regulated voltage VDDreg 254 node may be sensed in order to compensate for the ripple using the high-speed circuit. The low pass filter including the resistor 282 and a capacitor 258 may minimize the ripple at the supply of the three inverter amplifier stages 292. A single GM-GM stage 292 may consists of an inverter stage 260 and a shorted inverter 270 with a degenerative resistor, where the output of inverter stage 260 may be connected to the shorted inverter 270 with the degeneration resistor of the shorted inverter 270. The shorted inverter 270 may act as a load to inverter stage 260, decreasing its output impedance and increasing its bandwidth. The total gain of this GM-GM stage 260 may be dependent on the size of the degeneration resistors of shorted inverter 270. The three inverter amplifier stages 292 may include a first inverter stage 260, a second inverter stage 262, and a third inverter stage 264. Each inverter stage 260; 262; 264 may be comprised of a PMOS and an NMOS. A first shorted inverter 270, a second shorted inverter 272, and a third shorted inverter 274 each include degeneration resistors, which are used as low-impedance loads for the inverter stages 260; 262; 264, respectively, so that the GM-GM stages 292 can have higher bandwidth. The low pass filter supply voltage VDDreg_lpf 256 suppled to the inverter stages 260; 262; 264 may be the same low pass filter supply voltage VDDreg_lpf 256 suppled to the shorted inverters 270; 272; 274.

The inverter stages 260; 262; 264 and the shorted inverters 270; 272; 274 may have an impedance size or unit size. The size of the inverter stages 260; 262; 264 and the shorted inverters 270; 272; 274 may be relative to the size of one or more or the other inverter stages 260; 262; 264 and/or the other shorted inverters 270; 272; 274. As shown in FIG. 2B, sizes of the inverter stages 260; 262; 264 and the shorted inverters 270; 272; 274 may have a reference sizing, such as ×1, ×2, ×4, and ×8, with ×2 double the size of ×1, with ×4 double the size of ×2, and with ×8 double the size of ×4. The inverter stages 260; 262; 264 may be connected or cascaded with a shorted inverter 270; 272; 274 that may have degeneration resistors. The source of the inverter stages 260; 262; 264 may be connected in series with the source of the shorted inverters 270; 272; 274 to a ground. In an example, the input of the shorted inverters 270; 272; 274 and the output of the shorted inverters 270; 272; 274 may be shorted together as a resistance on the source of the inverter stages 260; 262; 264 towards the supply and connected in series. The inverter stages 260; 262; 264 may be the main GM element that receives the signal and then add gain. The shorted inverters 270; 272; 274 may act as a load as the shortage inverter. The shorted inverters 270; 272; 274 may have a low output impedance to provide higher bandwidth. The degeneration resistors of the shorted inverters 270; 272; 274 may load the signal with resistance and may add more gain.

As the signal, or the low pass filter supply voltage VDDreg_lpf 256 moves from one stage to the next stage of the three inverter amplifier stages 292 the inverters may double in size compared to the unit size of the previous inverter. This sizing may consume more current but may also increase drivability and may drive larger loads, in terms of parasitic capacitance, to higher frequency. The signal may increase in size and current when moves from one stage to the next stage of the three inverter amplifier stages 292. In the opposite path the resistance in the first stage of the three inverter amplifier stages 292 may have a higher resistance because of the lower amount of current. The degeneration resistors of the NMOS 270; 272; 274 may have a resistance value or unit value. The size of the degeneration resistors may be relative to the size of one or more or the other degeneration resistors. As shown in FIG. 2B, sizes of the degeneration resistors may have a reference sizing, such as 1R, 2R, and 4R, with 2R double the size of 1R and with 4R double the size of 2R. In an example, with 1R as the resistance reference value, then there may be four times that amount in the first stage and two times that amount in the second stage, and 1R in the third stage. The transitions provide a beneficial ratio between the resistance used at the current and the desired bandwidth. The more current going to the third stage of the three inverter amplifier stages 292, the less resistance there should be to increase drivability of the whole circuit in terms of bandwidth.

The PSRR boost loop features 250 may include an OTA 294 as part of a low-speed DC loop 296 or a very low speed DC loop 296. The low-speed DC loop 296 including the OTA 294 may keeping the outputs of NMOS 272 and NMOS 274 as equal as possible, with the goal of having the three GM-GM stages 292 biased at the middle, and providing the highest bandwidth. The low-speed DC loop 296 may attempt to reach this goal by biasing the input of the first GM-GM stage through the resistor R1 286. Depending on the level of the output regulated voltage VDDreg 254 or low pass filter supply voltage VDDreg_lpf 256 the inverters may have the maximum bandwidth and gain and be biased at the midpoint. For example, with about a 0.9 volt low pass filter supply voltage VDDreg_lpf 256 the output of the three inverter amplifier stages 292 may be at around 0.45 volts of biasing. Using the same type of inverters and the GM-GM topologies, with the increasing scaled sized of the inverters, the OTA 294 may correct the bias to the midpoint. The OTA 294 may move the bias to equalize the output of NMOS 272 and 274. The stability of the very low speed loop may be improved by the resistor R1 286 and the capacitor C1 288. The resistor R1 286 and the capacitor C1 288 may be used as the input high pass filter to the PSRR boost circuit 250. The resistor R1 286 and the capacitor C1 288 may compensate for the PSRR boost circuit 250 and stabilize the very slow DC loop 296.

In an embodiment, the PSRR boost loop 250 may be enable and disabled as needed. When enabled, the PSRR boost loop 250 may operate as otherwise described herein. To disable the PSRR boost loop 250, the low pass filter supply voltage VDDreg_lpf 256 may be shorted to a ground and disconnected from output regulated voltage VDDreg 254. When disabled, the PSRR boost loop 250 may not consume current. The PSRR boost loop 250 may be disabled during chip startup, power-down, hot-unplug, and the like. Disabling the PSRR boost loop 250 may protect the high-speed devices from safe-operating-area (SOA) violations.

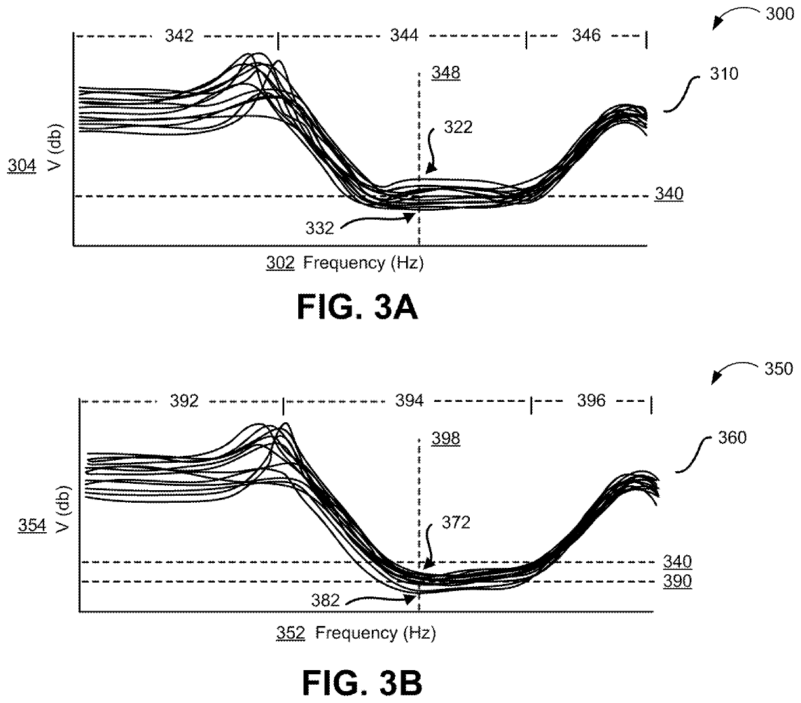

In at least one embodiment, waveform features 300 as illustrated in FIG. 3A may be associated with one or more features for improving PSRR of linear regulators to identify and correct noise or ripples within a circuit. In at least one embodiment, across a frequency range 302 a PSRR 304 of a plurality of PSRR waveforms 310 output from a linear regulator with PSRR boost loop enabled or active. The PSRR waveforms 310 may represent output under one or more condition variations, such as supply voltage variation, temperature variation, process variation, and the like. Within a low frequency range 342, such as at low frequencies, very low frequencies, DC frequencies, and the like, the PSRR 304 may be primarily determined by at least a main loop of the linear regulator and the PSRR boost circuit may have a limited effect on the PSRR waveforms 310. As may be typical with LDO linear regulators, the PSRR 304 within the low frequency range 342 may be effective at decreasing noise. Within a high frequency range 346, such as at high frequencies, very high frequencies, and the like, the PSRR 304 may be primarily determined by at least an output load capacitor of the linear regulator and the PSRR boost circuit may have a limited effect on the PSRR waveforms 310. As may be typical with LDO linear regulators, the PSRR 304 within the high frequency range 346 range may be effective at decreasing noise.

Within a middle frequency range 344, such as about between the low frequency range 342 and the high frequency range 346, the PSRR 304 may be primarily determined by at the PSRR boost circuit. As may be typical with LDO linear regulators, the PSRR 304 within the middle frequency range 344 may be less effective at decreasing noise than the PSRR 304 of the low frequency range 342 and the high frequency range 346. The enabled PSRR boost circuit may improve the PSRR 304 of the linear regulator in the middle frequency range 344 relative to linear regulators without the PSRR boost circuit or with the PSRR boost circuit disabled. The plurality of PSRR waveforms 310 of the linear regulator with the enabled PSRR boost circuit may have a mid-line PSRR 340 within the middle frequency range 344, with the mid-line PSRR 340 higher than that of linear regulators without the PSRR boost circuit or with the PSRR boost circuit disabled. At a reference frequency 348 within the middle frequency range 344 a best-case middle range PSRR 322 may be above the mid-line PSRR 340 and a worst-case middle range PSRR 332 may be below the mid-line PSRR 340. The best-case middle range PSRR 322 at the reference frequency 348 may have a higher PSRR 304 than the best-case middle range PSRR of linear regulators without the PSRR boost circuit or with the PSRR boost circuit disabled. The worst-case middle range PSRR 332 at the reference frequency 348 may have a higher PSRR 304 than the worst-case middle range PSRR of linear regulators without the PSRR boost circuit or with the PSRR boost circuit disabled. For example, at a reference frequency 348 between about 10 megahertz and 11 megahertz the best-case middle range PSRR 322 may be from about 31 decibels to about 32 decibels. For example, at a reference frequency 348 between about 10 megahertz and 11 megahertz the worst-case middle range PSRR 332 may be from about 24 decibels to about 25 decibels.

In at least one embodiment, waveform features 350 as illustrated in FIG. 3B may be associated with one or more features for improving the PSRR of linear regulators to identify and correct voltage noise or ripples within a circuit. In at least one embodiment, across a frequency range 352 a PSRR 354 of a plurality of PSRR waveforms 360 output from a linear regulator with the PSRR boost loop disabled, inactive, or without the PSRR boost loop. The PSRR waveforms 360 may represent output under one or more condition variations, such as supply voltage variation, temperature variation, process variation, and the like. Within a low frequency range 392, such as at low frequencies, very low frequencies, DC frequencies, and the like, the PSRR 354 may be primarily determined by at least a main loop of the linear regulator. As may be typical with LDO linear regulators, the PSRR 354 within the low frequency range 392 may be effective at decreasing noise. Within a high frequency range 396, such as at high frequencies, very high frequencies, and the like, the PSRR 354 may be primarily determined by at least an output load capacitor of the linear regulator. As may be typical with LDO linear regulators, the PSRR 354 within the high frequency range 396 may be effective at decreasing noise.

Within a middle frequency range 394, such as about between the low frequency range 392 and the high frequency range 396, the PSRR 354 may be primarily determined by other features than a PSRR boost circuit having the PSRR boost circuit disabled or the linear regulator does not include the PSRR boost circuit. As may be typical with LDO linear regulators, the PSRR 354 within the middle frequency range 394 may be less effective at decreasing noise than the PSRR 354 of the low frequency range 392 and the high frequency range 396. A linear regulator with a disabled PSRR boost circuit or a linear regulator without the PSRR boost circuit may have a lower PSRR 354 in the middle frequency range 394 relative to linear regulators with the PSRR boost circuit or with the PSRR boost circuit disabled. The plurality of PSRR waveforms 360 of the linear regulator with a disabled PSRR boost circuit or a linear regulator without the PSRR boost circuit may have a mid-line PSRR 390 within the middle frequency range 394, with the mid-line PSRR 390 lower than the mid-line PSRR 340 of linear regulators with the PSRR boost circuit enabled. At a reference frequency 398 within the middle frequency range 394 a best-case middle range PSRR 372 may be above the mid-line PSRR 390 and a worst-case middle range PSRR 382 may be below the mid-line PSRR 390. The best-case middle range PSRR 372 at the reference frequency 398 may have a lower PSRR 354 than the best-case middle range PSRR 372 of linear regulators with the PSRR boost circuit. The worst-case middle range PSRR 382 at the reference frequency 398 may have a lower PSRR 354 than the worst-case middle range PSRR 332 of linear regulators with the PSRR boost circuit. For example, at a reference frequency 398 between about 10 megahertz and 11 megahertz the best-case middle range PSRR 372 may be about from about 24 decibels to about 26 decibels. For example, at a reference frequency 398 between about 10 megahertz and 11 megahertz the worst-case middle range PSRR 382 may be from about 20 decibels to about 21 decibels.

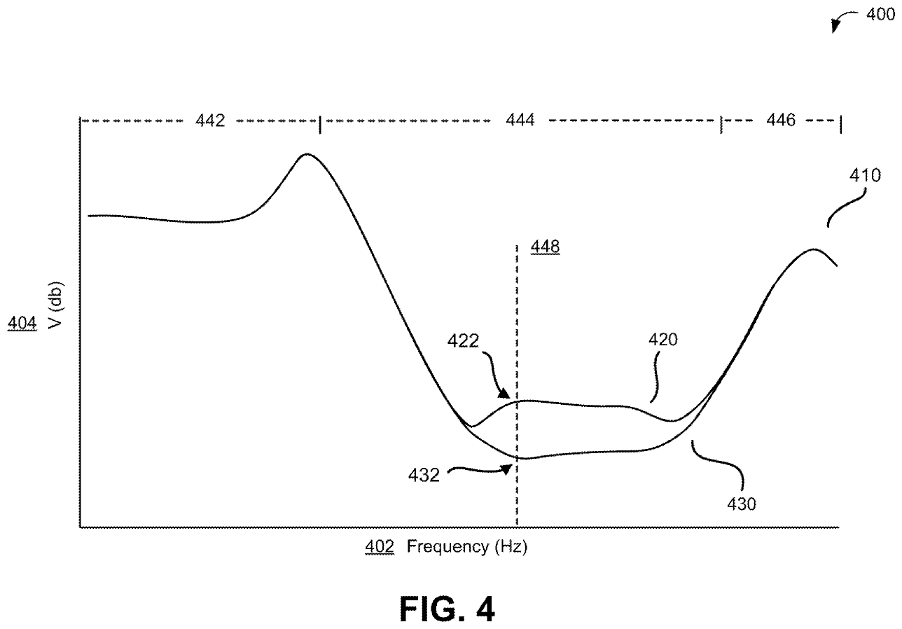

In at least one embodiment, waveform features 400 as illustrated in FIG. 4 may be associated with one or more features for improving the PSRR of linear regulators to identify and correct voltage noise or ripples within a circuit. In at least one embodiment, across a frequency range 402 a PSRR 404 of a plurality of PSRR waveforms 410 output from a linear regulator with both the PSRR boost loop enabled and the PSRR boost loop disabled, inactive, or without the PSRR boost loop provided. The PSRR waveforms 410 may include a PSRR boost loop enabled PSRR waveform 420 and a PSRR boost loop disabled PSRR waveform 430. In an embodiment, the PSRR boost loop enabled PSRR waveform 420 may be output from a linear regulator with PSRR boost loop enabled. In an embodiment, the PSRR boost loop disabled PSRR waveform 430 may be output from a linear regulator with PSRR boost loop disabled, inactive, or without the PSRR boost loop. The PSRR waveforms 410 may represent output under one or more condition variations, such as supply voltage variation, temperature variation, process variation, and the like. Within a low frequency range 442, such as at low frequencies, very low frequencies, DC frequencies, and the like, the PSRR 404 may be primarily determined by at least a main loop of the linear regulator and the PSRR boost circuit may have a limited effect on the PSRR waveforms 410. As may be typical with LDO linear regulators, the PSRR 404 within the low frequency range 442 may be effective at decreasing noise. Within a high frequency range 446, such as at high frequencies, very high frequencies, and the like, the PSRR 404 may be primarily determined by at least an output load capacitor of the linear regulator and the PSRR boost circuit may have a limited effect on the PSRR waveforms 410. As may be typical with LDO linear regulators, the PSRR 404 within the high frequency range 446 range may be high and effective at decreasing noise.

Within a middle frequency range 444, such as about between the low frequency range 442 and the high frequency range 446, the PSRR 404 may be primarily determined by at the PSRR boost circuit for the enabled PSRR waveform 420. Within a middle frequency range 444, such as about between the low frequency range 442 and the high frequency range 446, the PSRR 404 may be primarily determined by other features than a PSRR boost circuit for the disabled PSRR waveform 430. As may be typical with LDO linear regulators, the PSRR 404 within the middle frequency range 444 may be lower and less effective at decreasing noise than the PSRR 404 of the low frequency range 442 and the high frequency range 446.

The enabled PSRR boost circuit may improve the PSRR 404 of the linear regulator in the middle frequency range 444 relative to linear regulators without the PSRR boost circuit or with the PSRR boost circuit disabled. A best-case middle range PSRR 422 of the enabled PSRR waveform 420 at the reference frequency 448 may have a higher PSRR 404 than the best-case middle range PSRR 432 of the disabled PSRR waveform 430. For example, at a reference frequency 448 between about 10 megahertz and 11 megahertz the best-case middle range PSRR 422 of the enabled PSRR waveform 420 may be from about 31 decibels to about 32 decibels. For example, at a reference frequency 448 between about 10 megahertz and 11 megahertz the best-case middle range PSRR 432 of the disabled PSRR waveform 430 may be about from about 24 decibels to about 26 decibels.

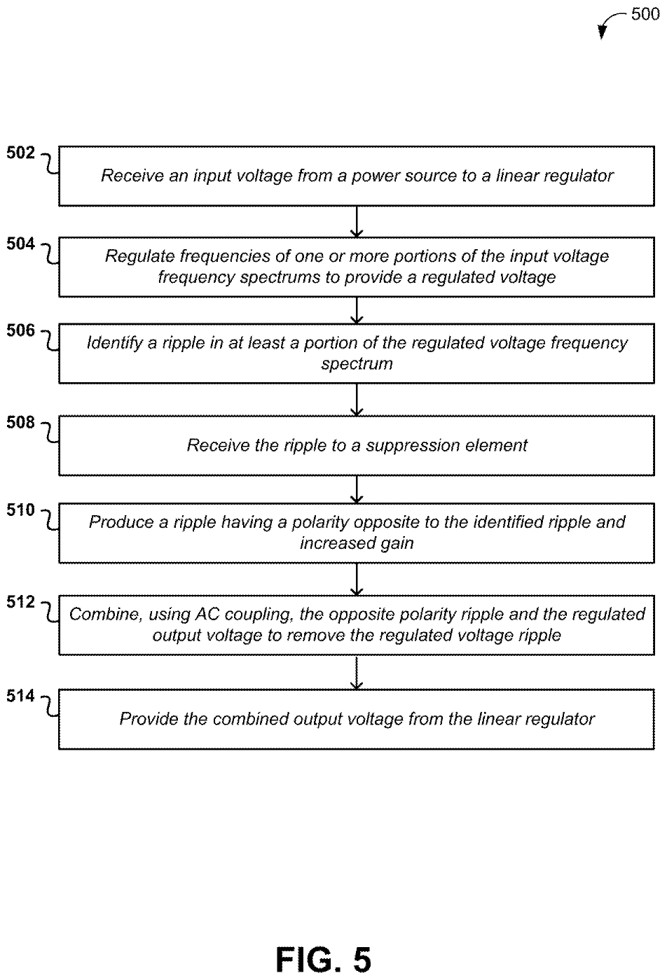

FIG. 5 illustrates an example process 500 that can be associated with a linear regulator such as that described with respect to FIGS. 1-4, in accordance with at least one embodiment. It should be understood that for this and other processes presented herein that there can be additional, fewer, or alternative operations performed in similar or alternative order, or at least partially in parallel, within the scope of various embodiments unless otherwise specifically stated. In this example, an input voltage is received 502 to a linear regulator. The input voltage may be received from a power source, such as an external power source, voltage supply, or the like. The input may include noise or a ripple at one or more frequencies. The linear regulator be associated and/or integrated with a microchip, GPU, and the like. The linear regulator may include circuit elements or electrical components, loops, circuits, and the like. The frequencies of one or more portions of the input voltage may be regulated 504 to generate a output regulated voltage. The one or more portions of the input voltage may be within one or more frequency ranges. The output regulated voltage may be regulated within a low frequency range and a high frequency range. A ripple in at least a portion of the output regulated voltage may be sensed 506. The sensed ripple of the output regulated voltage may be within a frequency range between about the low frequency range and the high frequency range. The sensed ripple may be unwanted noise or variation from the input voltage.

The sensed ripple in this example may be received 508 to a PSRR boost loop. The PSRR boost loop may be a circuit of the linear regulator. The PSRR boost loop may receive a portion of the output regulated voltage as the ripple. The PSRR boost loop may be connected to a main loop of the linear regulator using a pass device. In an embodiment, the pass device may be a NMOS pass device connected to the linear regulator and configured as a source follower. The PSRR boost loop may be connected to a portion of the pass device. In an embodiment, the PSRR boost loop may include three GM-GM inverter amplifiers and a slow loop including an OTA. A ripple may be produced 510 by the PSRR boost loop with an inverted polarity to the identified ripple and higher gain than the identified ripple. The inverted polarity ripple may be applied 512 from the PSRR boost loop at the output regulated voltage to remove or suppress the ripple. In an embodiment, the inverted polarity ripple removes or suppresses the ripple. The inverted polarity ripple may be provided to the output regulated voltage using AC coupling. The output regulated voltage combined with the inverted polarity ripple may be provided 514 from the linear regulator. The combined output voltage may be provided to one or more circuits of the microchip.

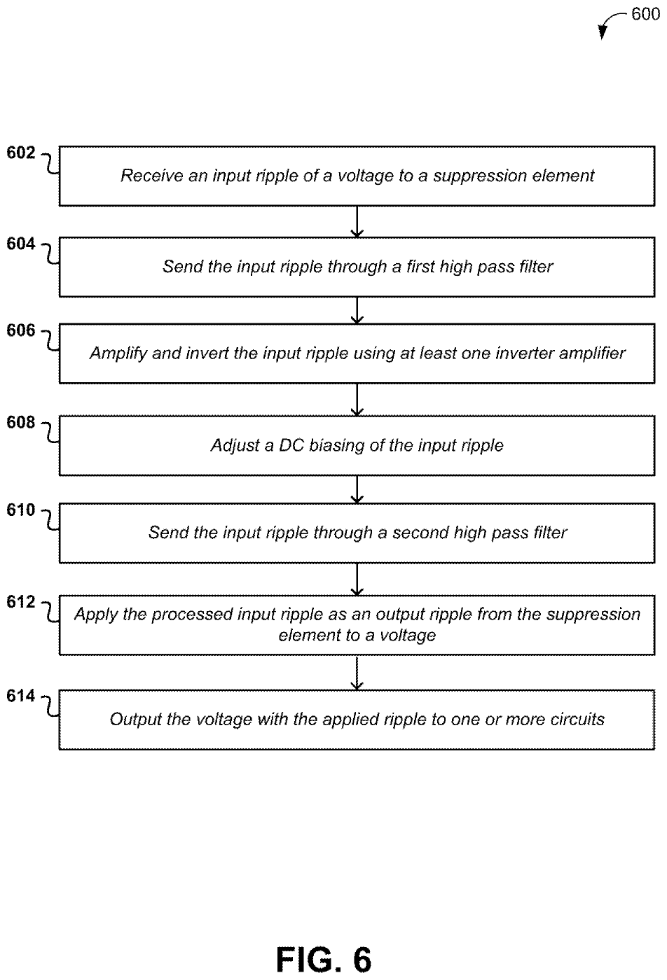

FIG. 6 illustrates an example process 600 that can be associated with a linear regulator, such as that described with respect to FIGS. 1-4, in accordance with at least one embodiment. In this example, an input ripple is received 602 to a PSRR boost loop. The input ripple may be provided from an external voltage source and may first be processed by a main loop of the linear regulator. The PSRR boost loop may be a circuit of a linear regulator. The input ripple may correspond to a portion of a voltage that includes noise within a frequency range. The input ripple may be sent 604 through a first high pass filter of the PSRR boost loop to provide only a portion of the input ripple frequency range, such as the middle frequency range. The first high pass filter in this example may include at least a resistor and a capacitor. The first high pass filter may connect part of the PSRR boost loop to the linear regulator. The input ripple may be amplified and inverted 606 using one or more inverter amplifiers of the PSRR boost loop. Three GM-GM inverter amplifiers may be used as the inverter amplifiers. The DC biasing of the input ripple may be adjusted 608 to correct the biasing of the inverter amplifiers to provide the best combination of maximum gain and maximum bandwidth. A low speed loop with an OTA may controlling the DC bias point. The input ripple may be sent 610 through a second high pass filter of the PSRR boost loop to provide only a portion of the input ripple frequency range out of the PSRR boost loop, such as the middle frequency range. The second high pass filter may also include a resistor and a capacitor. The second high pass filter may connect another part of the PSRR boost loop to the linear regulator. The use of two high pass filters allows for connecting the regulated voltage and the signal of the PSRR boost loop with AC coupling. After traveling through the PSRR boost loop, the processed ripple may be applied 612 as an output ripple from the PSRR boost loop at the voltage to correct, suppress, modify, or minimize at least part of the voltage ripple. After applying the output ripple, the voltage may be well controlled and quiet in terms of noise and supply ripple. The voltage with the combined input ripple and output ripple may be provided 614 to one or more circuits.

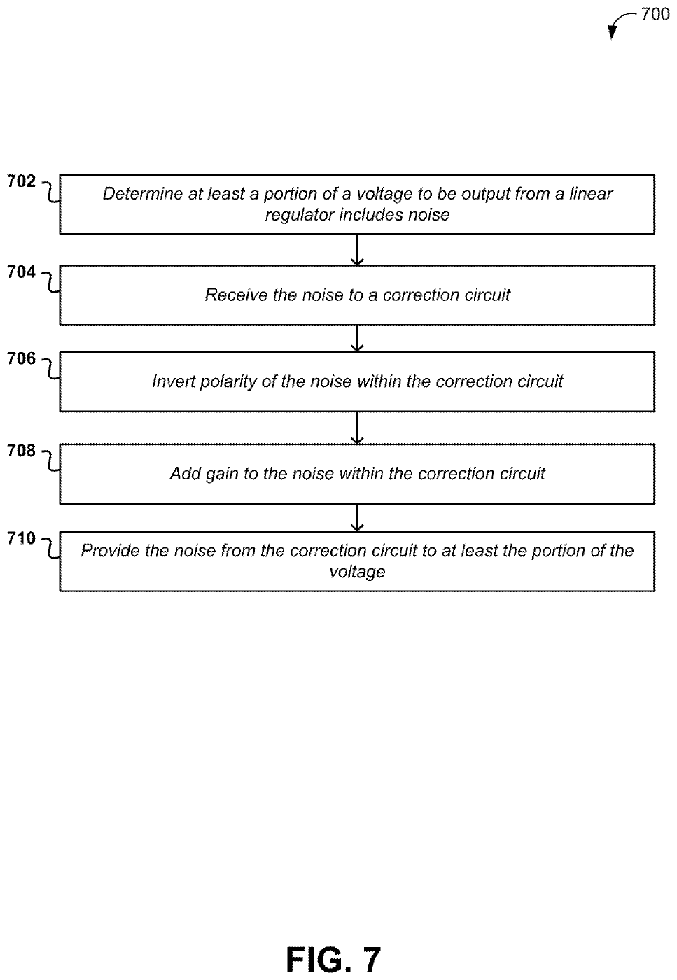

In at least one embodiment, FIG. 7 illustrates an example process 700 that can be associated with a linear regulator of FIGS. 1-4. In at least one embodiment, such a process 700 includes at least a frequency portion of a voltage to be output from a linear regulator is determined 702 to include noise. The voltage may be supplied to the linear regulator by an external voltage supply of a fixed power level. The noise of the voltage may be a signal variation, such as a ripple, in low, middle, and high frequency ranges. In an embodiment, the voltage may be equalized using an using an error amplifier to provide an regulated voltage. The low frequency portion of the ripple may be corrected using a main loop of the linear regulator. The high frequency portion of the ripple may be suppressed using a load capacitor. The middle frequency portion of the ripple may be greater than at least some of the low frequency portion. The middle frequency portion of the ripple may be less than at least some of the high frequency. The noise of at least the middle frequency portion of a voltage may be received 704 to the correction circuit. The high frequency portion of a voltage may also be received to the correction circuit. The correction circuit may be connected around a fraction of a pass device connecting the correction circuit to a main circuit. The polarity of the noise may be reversed 706 within the correction circuit to produce an inverted polarity ripple. The inverted polarity ripple may be produced using three cascaded gm-gm inverter stages, where each of the stages may include a high-speed inverter followed by a shorted inverter with degeneration resistors. Gain may be added 708 to the noise within the correction circuit. Loading each inverter with a shorted inverter may increases bandwidth, and the degeneration resistors may provide gain for each stage. Each subsequent stage may be doubled in size and current consumption, which may produce higher driving capability. The high-speed stages may use a low-pass filtered output regulated voltage as the voltage supply. A low-speed loop, internal to the correction circuit, may correctly bias the DC levels of the high-speed inverter stages. The processed noise from the correction circuit may be supplied 710 to at least the middle frequency portion of the voltage.

### Data Center

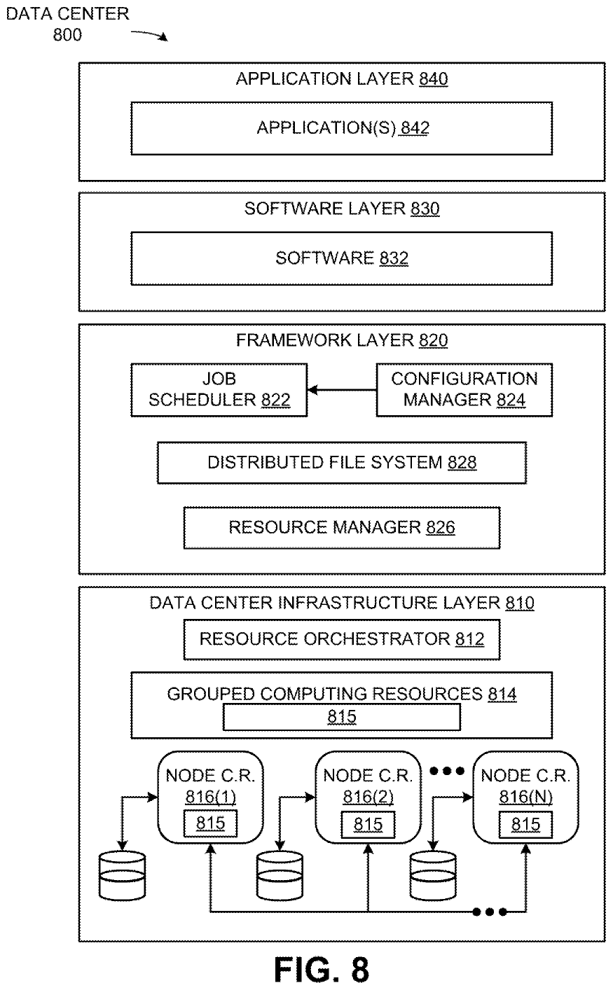

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents a positive integer (which may be a different integer “N” than used in other figures). In at least one embodiment, node C.R.s 816(1)-816(N) may include, but are not limited to, any number of central processing units (“CPUs”) or other processors (including accelerators, field programmable gate arrays (FPGAs), graphics processors, etc.), memory storage devices 818(1)-818(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). In at least one embodiment, separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 612 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resources 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. In at least one embodiment, one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. In at least one embodiment, inference and/or training logic 815 may be used in system FIG. 8 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

### Computer Systems

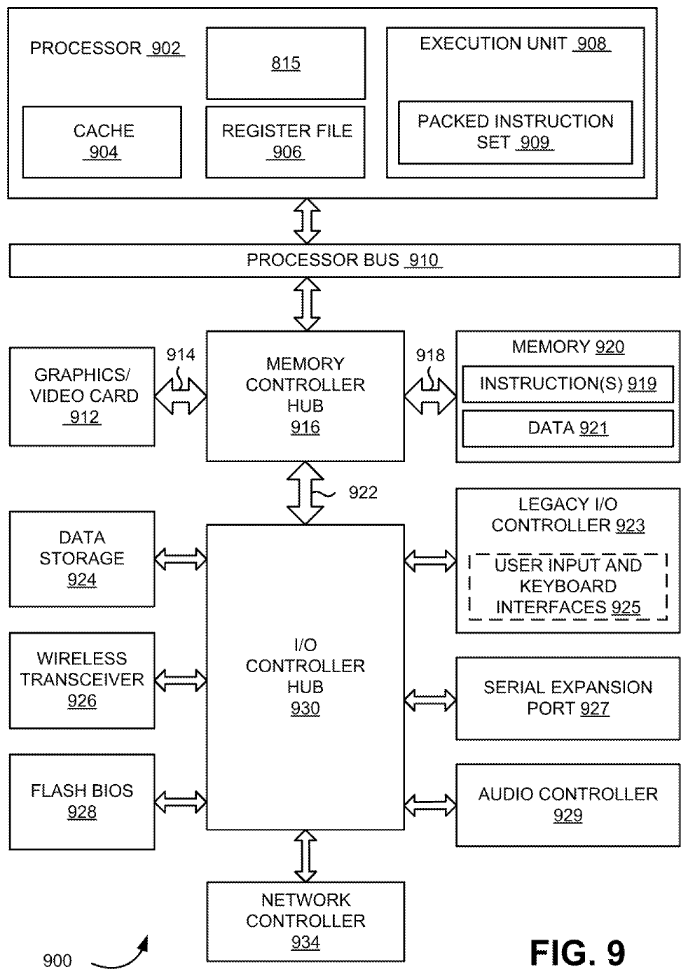

FIG. 9 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, a register file 906 may store different types of data in various registers including, without limitation, integer registers, floating point registers, status registers, and an instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor, along with associated circuitry to execute instructions, operations used by many multimedia applications may be performed using packed data in processor 902. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be a Dynamic Random Access Memory (“DRAM”) device, a Static Random Access Memory (“SRAM”) device, a flash memory device, or another memory device. In at least one embodiment, memory 920 may store instruction(s) 919 and/or data 921 represented by data signals that may be executed by processor 902.

In at least one embodiment, a system logic chip may be coupled to processor bus 910 and memory 920. In at least one embodiment, a system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data, and textures. In at least one embodiment, MCH 916 may direct data signals between processor 902, memory 920, and other components in computer system 900 and to bridge data signals between processor bus 910, memory 920, and a system I/O interface 922. In at least one embodiment, a system logic chip may provide a graphics port for coupling to a graphics controller. In at least one embodiment, MCH 916 may be coupled to memory 920 through high bandwidth memory path 918 and a graphics/video card 912 may be coupled to MCH 916 through an Accelerated Graphics Port (“AGP”) interconnect 914.

In at least one embodiment, computer system 900 may use system I/O interface 922 as a proprietary hub interface bus to couple MCH 916 to an I/O controller hub (“ICH”) 930. In at least one embodiment, ICH 930 may provide direct connections to some I/O devices via a local I/O bus. In at least one embodiment, a local I/O bus may include, without limitation, a high-speed I/O bus for connecting peripherals to memory 920, a chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as a Universal Serial Bus (“USB”) port, and a network controller 934. In at least one embodiment, data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary SoC. In at least one embodiment, devices illustrated in FIG. 9 may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 815 are used to perform inferencing and/or training operations associated with one or more embodiments. In at least one embodiment, inference and/or training logic 815 may be used in system FIG. 9 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

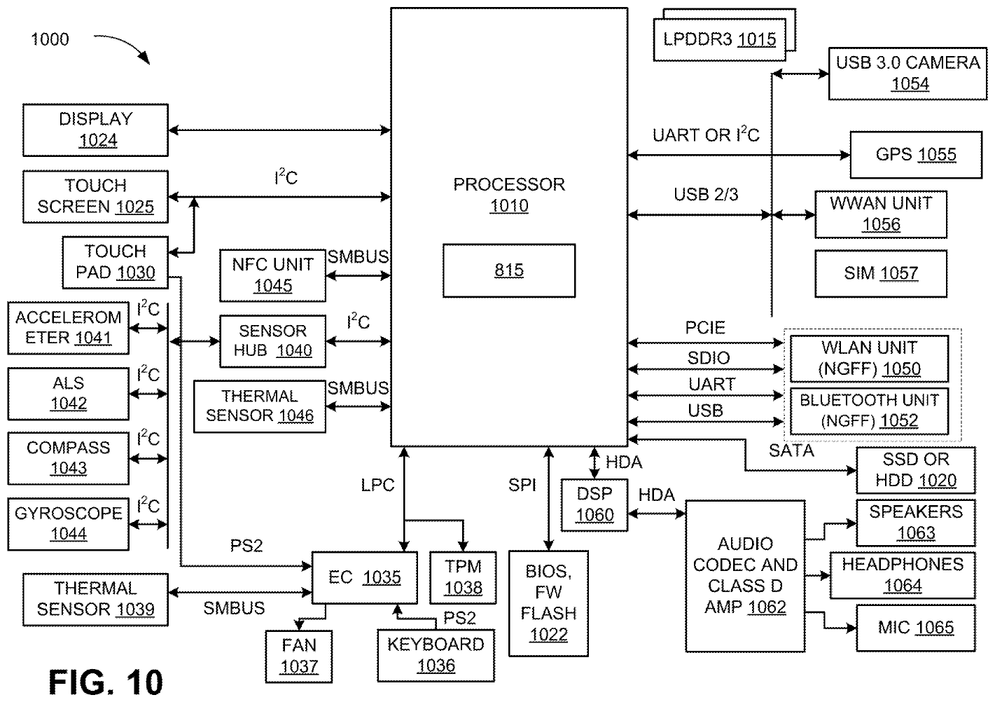

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 is coupled using a bus or interface, such as a I²C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary SoC. In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) unit 1055, a camera (“USB 3.0 camera”) 1054 such as a USB 3.0 camera, and/or a Low Power Double Data Rate (“LPDDR”) memory unit (“LPDDR3”) 1015 implemented in, for example, an LPDDR3 standard. These components may each be implemented in any suitable manner.

In at least one embodiment, other components may be communicatively coupled to processor 1010 through components described herein. In at least one embodiment, an accelerometer 1041, an ambient light sensor (“ALS”) 1042, a compass 1043, and a gyroscope 1044 may be communicatively coupled to sensor hub 1040. In at least one embodiment, a thermal sensor 1039, a fan 1037, a keyboard 1036, and touch pad 1030 may be communicatively coupled to EC 1035. In at least one embodiment, speakers 1063, headphones 1064, and a microphone (“mic”) 1065 may be communicatively coupled to an audio unit (“audio codec and class D amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, a SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 815 are used to perform inferencing and/or training operations associated with one or more embodiments. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

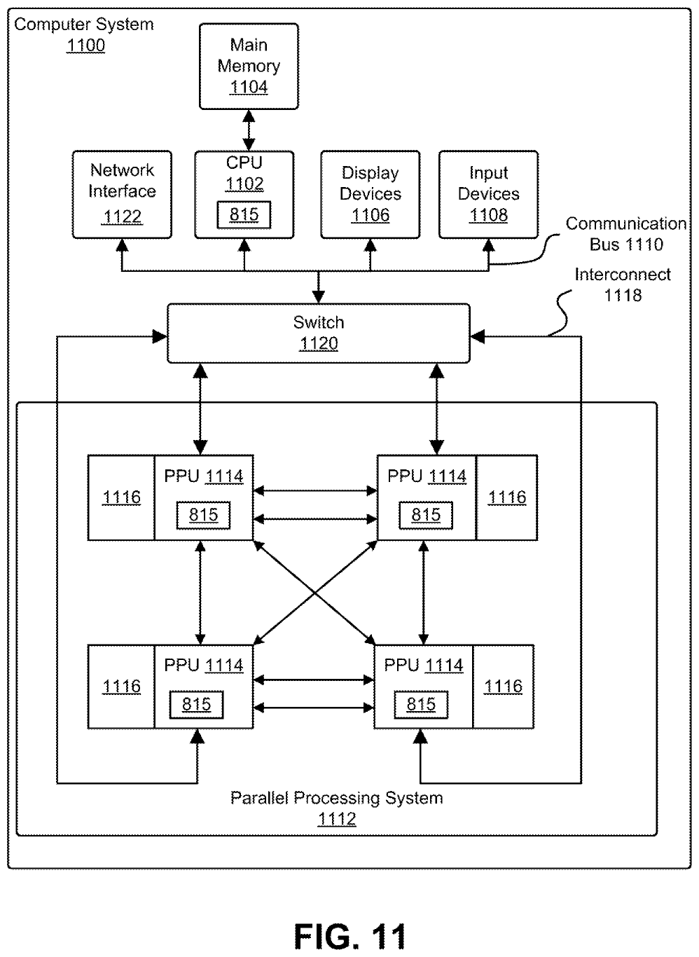

FIG. 11 illustrates a computer system 1100, according to at least one embodiment. In at least one embodiment, computer system 1100 is configured to implement various processes and methods described throughout this disclosure.

In at least one embodiment, computer system 1100 comprises, without limitation, at least one central processing unit (“CPU”) 1102 that is connected to a communication bus 1110 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 1100 includes, without limitation, a main memory 1104 and control logic (e.g., implemented as hardware, software, or a combination thereof) and data are stored in main memory 1104, which may take form of random access memory (“RAM”). In at least one embodiment, a network interface subsystem (“network interface”) 1122 provides an interface to other computing devices and networks for receiving data from and transmitting data to other systems with computer system 1100.

In at least one embodiment, computer system 1100, in at least one embodiment, includes, without limitation, input devices 1108, a parallel processing system 1112, and display devices 1106 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 1108 such as keyboard, mouse, touchpad, microphone, etc. In at least one embodiment, each module described herein can be situated on a single semiconductor platform to form a processing system.

Inference and/or training logic 815 are used to perform inferencing and/or training operations associated with one or more embodiments. In at least one embodiment, inference and/or training logic 815 may be used in system FIG. 11 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

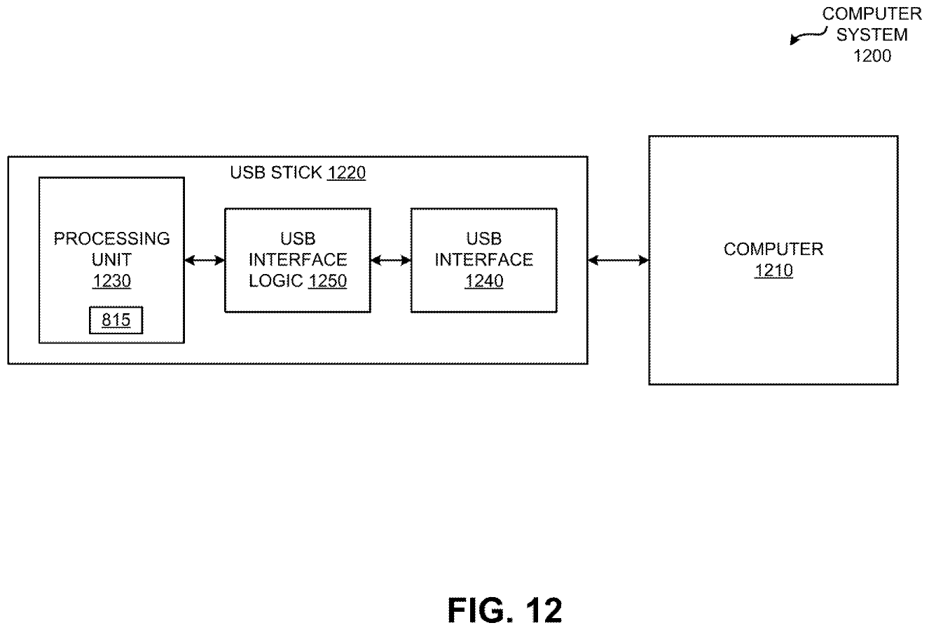

FIG. 12 illustrates a computer system 1200, according to at least one embodiment. In at least one embodiment, computer system 1200 includes, without limitation, a computer 1210 and a USB stick 1220. In at least one embodiment, computer 1210 may include, without limitation, any number and type of processor(s) (not shown) and a memory (not shown). In at least one embodiment, computer 1210 includes, without limitation, a server, a cloud instance, a laptop, and a desktop computer.

In at least one embodiment, USB stick 1220 includes, without limitation, a processing unit 1230, a USB interface 1240, and USB interface logic 1250. In at least one embodiment, processing unit 1230 may be any instruction execution system, apparatus, or device capable of executing instructions. In at least one embodiment, processing unit 1230 may include, without limitation, any number and type of processing cores (not shown). In at least one embodiment, processing unit 1230 comprises an application specific integrated circuit (“ASIC”) that is optimized to perform any amount and type of operations associated with machine learning. For instance, in at least one embodiment, processing unit 1230 is a tensor processing unit (“TPC”) that is optimized to perform machine learning inference operations. In at least one embodiment, processing unit 1230 is a vision processing unit (“VPU”) that is optimized to perform machine vision and machine learning inference operations.

In at least one embodiment, USB interface 1240 may be any type of USB connector or USB socket. For instance, in at least one embodiment, USB interface 1240 is a USB 3.0 Type-C socket for data and power. In at least one embodiment, USB interface 1240 is a USB 3.0 Type-A connector. In at least one embodiment, USB interface logic 1250 may include any amount and type of logic that enables processing unit 1230 to interface with devices (e.g., computer 1210) via USB connector 1240.

Inference and/or training logic 815 are used to perform inferencing and/or training operations associated with one or more embodiments. In at least one embodiment, inference and/or training logic 815 may be used in system FIG. 12 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

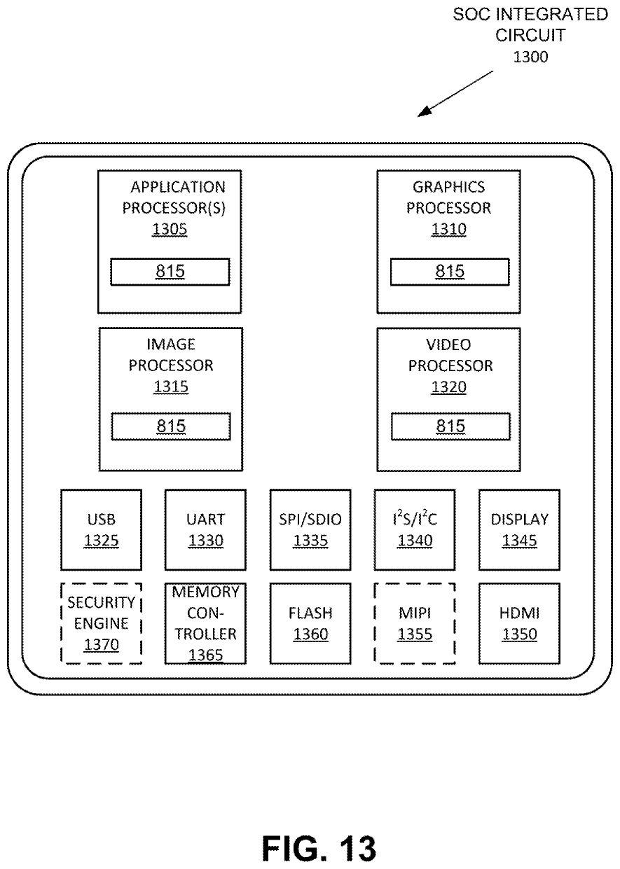

FIG. 13 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 13 is a block diagram illustrating an exemplary system-on-a-chip (SOC) integrated circuit 1300 that may be fabricated using one or more IP cores, according to at least one embodiment. In at least one embodiment, SOC integrated circuit 1300 includes one or more application processor(s) 1305 (e.g., CPUs), at least one graphics processor 1310, and may additionally include an image processor 1315 and/or a video processor 1320, any of which may be a modular IP core. In at least one embodiment, SOC integrated circuit 1300 includes peripheral or bus logic including a USB controller 1325, a UART controller 1330, an SPI/SDIO controller 1335, and an I²2S/I²2C controller 1340. In at least one embodiment, SOC integrated circuit 1300 can include a display device 1345 coupled to one or more of a high-definition multimedia interface (HDMI) controller 1350 and a mobile industry processor interface (MIPI) display interface 1355. In at least one embodiment, storage may be provided by a flash memory subsystem 1360 including flash memory and a flash memory controller. In at least one embodiment, a memory interface may be provided via a memory controller 1365 for access to SDRAM or SRAM memory devices. In at least one embodiment, some integrated circuits additionally include an embedded security engine 1370.

Inference and/or training logic 815 are used to perform inferencing and/or training operations associated with one or more embodiments. In at least one embodiment, inference and/or training logic 815 may be used in SOC integrated circuit 1300 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

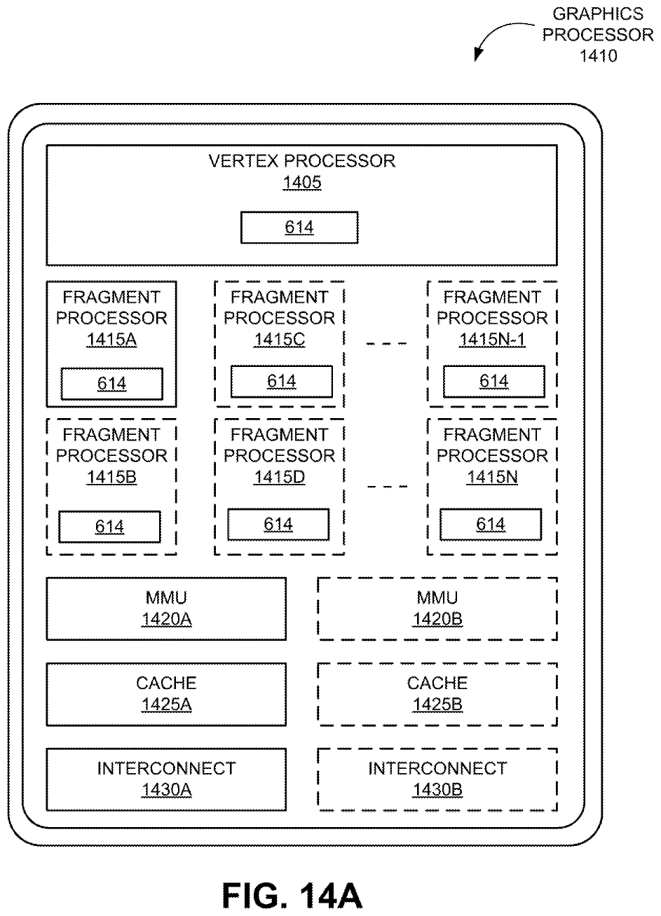

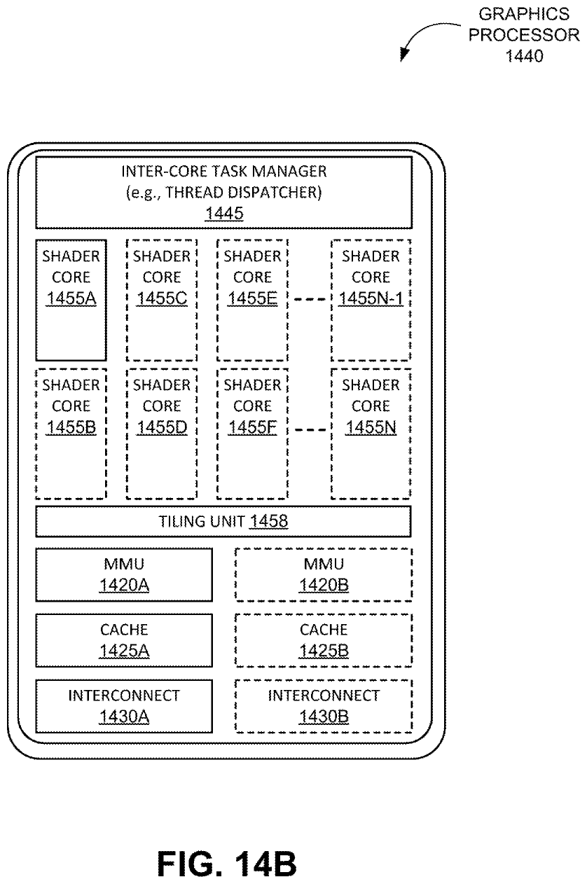

FIGS. 14A-14B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 14A-14B are block diagrams illustrating exemplary graphics processors for use within an SoC, according to embodiments described herein. FIG. 14A illustrates an exemplary graphics processor 1410 of a system on a chip integrated circuit that may be fabricated using one or more IP cores, according to at least one embodiment. FIG. 14B illustrates an additional exemplary graphics processor 1440 of a system on a chip integrated circuit that may be fabricated using one or more IP cores, according to at least one embodiment. In at least one embodiment, graphics processor 1410 of FIG. 14A is a low power graphics processor core. In at least one embodiment, graphics processor 1440 of FIG. 14B is a higher performance graphics processor core. In at least one embodiment, each of graphics processors 1410, 1440 can be variants of computer system 1200 of FIG. 12.

In at least one embodiment, graphics processor 1410 includes a vertex processor 1405 and one or more fragment processor(s) 1415A-1415N (e.g., 1415A, 1415B, 1415C, 1415D, through 1415N-1, and 1415N). In at least one embodiment, graphics processor 1410 can execute different shader programs via separate logic, such that vertex processor 1405 is optimized to execute operations for vertex shader programs, while one or more fragment processor(s) 1415A-1415N execute fragment (e.g., pixel) shading operations for fragment or pixel shader programs. In at least one embodiment, vertex processor 1405 performs a vertex processing stage of a 3D graphics pipeline and generates primitives and vertex data. In at least one embodiment, fragment processor(s) 1415A-1415N use primitive and vertex data generated by vertex processor 1405 to produce a framebuffer that is displayed on a display device. In at least one embodiment, fragment processor(s) 1415A-1415N are optimized to execute fragment shader programs as provided for in an OpenGL API, which may be used to perform similar operations as a pixel shader program as provided for in a Direct 3D API.

In at least one embodiment, graphics processor 1410 additionally includes one or more memory management units (MMUs) 1420A-1420B, cache(s) 1425A-1425B, and circuit interconnect(s) 1430A-1430B. In at least one embodiment, one or more MMU(s) 1420A-1420B provide for virtual to physical address mapping for graphics processor 1410, including for vertex processor 1405 and/or fragment processor(s) 1415A-1415N, which may reference vertex or image/texture data stored in memory, in addition to vertex or image/texture data stored in one or more cache(s) 1425A-1425B. In at least one embodiment, one or more MMU(s) 1420A-1420B may be synchronized with other MMUs within a system, including one or more MMUs associated with one or more application processor(s) 1405, image processors 1415, and/or video processors 1420 of FIG. 14A, such that each processor 1405-1420 can participate in a shared or unified virtual memory system. In at least one embodiment, one or more circuit interconnect(s) 1430A-1430B enable graphics processor 1410 to interface with other IP cores within SoC, either via an internal bus of SoC or via a direct connection.

In at least one embodiment, graphics processor 1440 includes one or more shader core(s) 1455A-1455N (e.g., 1455A, 1455B, 1455C, 1455D, 1455E, 1455F, through 1455N-1, and 1455N) as shown in FIG. 14B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1440 includes an inter-core task manager 1445, which acts as a thread dispatcher to dispatch execution threads to one or more shader cores 1455A-1455N and a tiling unit 1458 to accelerate tiling operations for tile-based rendering, in which rendering operations for a scene are subdivided in image space, for example to exploit local spatial coherence within a scene or to optimize use of internal caches.

Embodiments presented herein can allow for a linear regulator with one or more features for improving the PSRR to identify and correct voltage noise within a circuit.

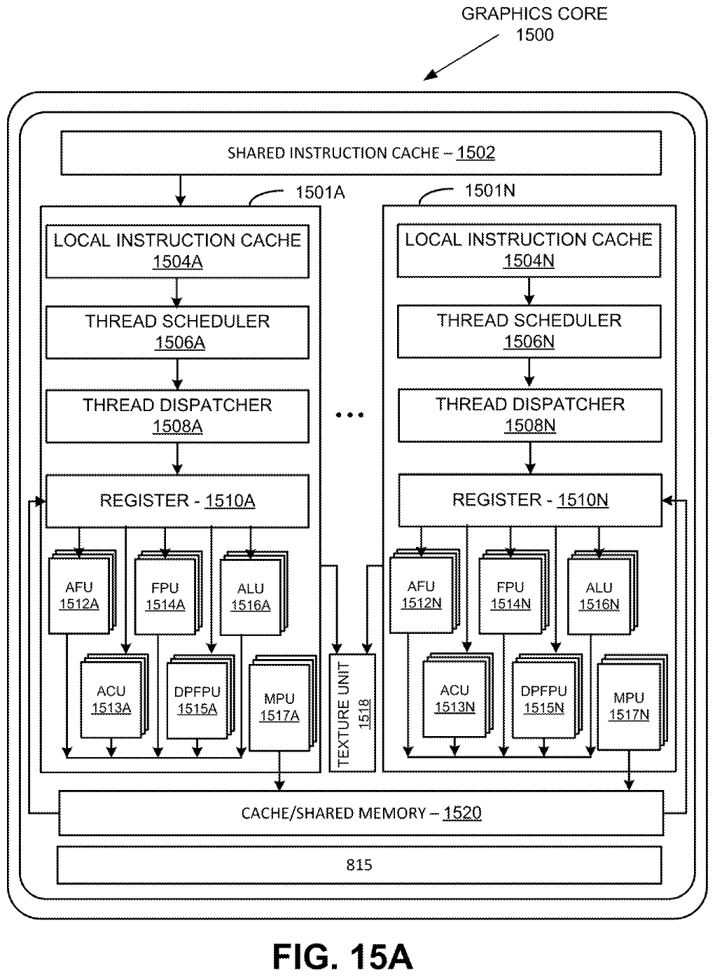

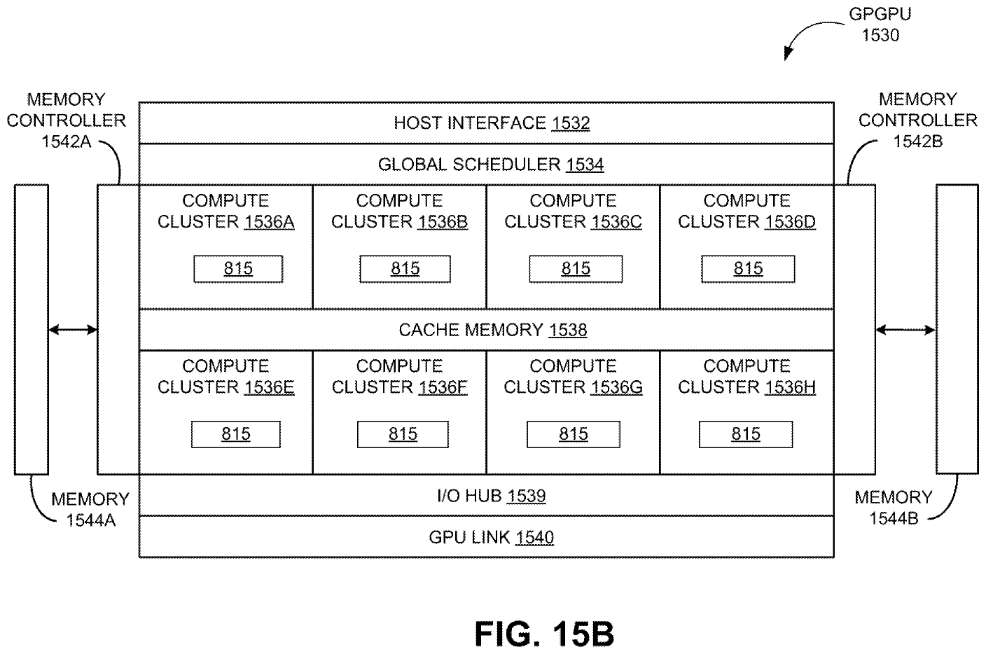

FIGS. 15A-15B illustrate additional exemplary graphics processor logic according to embodiments described herein. FIG. 15A illustrates a graphics core 1500 that may be included within graphics processor 1310 of FIG. 13, in at least one embodiment, and may be a unified shader core 1355A-1355N as in FIG. 13 in at least one embodiment. FIG. 15B illustrates a highly-parallel general-purpose graphics processing unit (“GPGPU”) 1530 suitable for deployment on a multi-chip module in at least one embodiment.

In at least one embodiment, graphics core 1500 includes a shared instruction cache 1502, a texture unit 1518, and a cache/shared memory 1520 (e.g., including L1, L2, L3, last level cache, or other caches) that are common to execution resources within graphics core 1500. In at least one embodiment, graphics core 1500 can include multiple slices 1501A-1501N or a partition for each core, and a graphics processor can include multiple instances of graphics core 1500. In at least one embodiment, each slice 1501A-1501N refers to graphics core 1500. In at least one embodiment, slices 1501A-1501N have sub-slices, which are part of a slice 1501A-1501N. In at least one embodiment, slices 1501A-1501N are independent of other slices or dependent on other slices. In at least one embodiment, slices 1501A-1501N can include support logic including a local instruction cache 1504A-1504N, a thread scheduler (sequencer) 1506A-1506N, a thread dispatcher 1508A-1508N, and a set of registers 1510A-1510N. In at least one embodiment, slices 1501A-1501N can include a set of additional function units (AFUs 1512A-1512N), floating-point units (FPUs 1514A-1514N), integer arithmetic logic units (ALUs 1516A-1516N), address computational units (ACUs 1513A-1513N), double-precision floating-point units (DPFPUs 1515A-1515N), and matrix processing units (MPUs 1517A-1517N).

In at least one embodiment, each slice 1501A-1501N includes one or more engines for floating point and integer vector operations and one or more engines to accelerate convolution and matrix operations in AI, machine learning, or large dataset workloads. In at least one embodiment, one or more slices 1501A-1501N include one or more vector engines to compute a vector (e.g., compute mathematical operations for vectors). In at least one embodiment, a vector engine can compute a vector operation in 15-bit floating point (also referred to as “FP16”), 32-bit floating point (also referred to as “FP32”), or 64-bit floating point (also referred to as “FP64”). In at least one embodiment, one or more slices 1501A-1501N includes 15 vector engines that are paired with 15 matrix math units to compute matrix/tensor operations, where vector engines and math units are exposed via matrix extensions. In at least one embodiment, a slice a specified portion of processing resources of a processing unit, e.g., 15 cores and a ray tracing unit or 8 cores, a thread scheduler, a thread dispatcher, and additional functional units for a processor. In at least one embodiment, graphics core 1500 includes one or more matrix engines to compute matrix operations, e.g., when computing tensor operations.

In at least one embodiment, one or more slices 1501A-1501N includes one or more ray tracing units to compute ray tracing operations (e.g., 15 ray tracing units per slice slices 1501A-1501N). In at least one embodiment, a ray tracing unit computes ray traversal, triangle intersection, bounding box intersect, or other ray tracing operations.

In at least one embodiment, one or more slices 1501A-1501N includes a media slice that encodes, decodes, and/or transcodes data; scales and/or format converts data; and/or performs video quality operations on video data.

In at least one embodiment, one or more slices 1501A-1501N are linked to L2 cache and memory fabric, link connectors, high-bandwidth memory (HBM) (e.g., HBM2e, HDM3) stacks, and a media engine. In at least one embodiment, one or more slices 1501A-1501N include multiple cores (e.g., 15 cores) and multiple ray tracing units (e.g., 15) paired to each core. In at least one embodiment, one or more slices 1501A-1501N has one or more L1 caches. In at least one embodiment, one or more slices 1501A-1501N include one or more vector engines; one or more instruction caches to store instructions; one or more L1 caches to cache data; one or more shared local memories (SLMs) to store data, e.g., corresponding to instructions; one or more samplers to sample data; one or more ray tracing units to perform ray tracing operations; one or more geometries to perform operations in geometry pipelines and/or apply geometric transformations to vertices or polygons; one or more rasterizers to describe an image in vector graphics format (e.g., shape) and convert it into a raster image (e.g., a series of pixels, dots, or lines, which when displayed together, create an image that is represented by shapes); one or more a Hierarchical Depth Buffer (Hiz) to buffer data; and/or one or more pixel backends. In at least one embodiment, a slice 1501A-1501N includes a memory fabric, e.g., an L2 cache.

In at least one embodiment, FPUs 1514A-1514N can perform single-precision (32-bit) and half-precision (16-bit) floating point operations, while DPFPUs 1815A-1815N perform double precision (64-bit) floating point operations. In at least one embodiment, ALUs 1516A-1516N can perform variable precision integer operations at 8-bit, 15-bit, and 32-bit precision, and can be configured for mixed precision operations. In at least one embodiment, MPUs 1517A-1517N can also be configured for mixed precision matrix operations, including half-precision floating point and 8-bit integer operations. In at least one embodiment, MPUs 1517-1517N can perform a variety of matrix operations to accelerate machine learning application frameworks, including enabling support for accelerated general matrix to matrix multiplication (GEMM). In at least one embodiment, AFUs 1512A-1512N can perform additional logic operations not supported by floating-point or integer units, including trigonometric operations (e.g., sine, cosiInference and/or training logic 815 are used to perform inferencing and/or training operations associated with one or more embodiments. In at least one embodiment, inference and/or training logic 815 may be used in graphics core 1500 for inferencing or predicting operations based, at least in part, on weight parameters calculated using neural network training operations, neural network functions and/or architectures, or neural network use cases described herein.

In at least one embodiment, graphics core 1500 includes an interconnect and a link fabric sublayer that is attached to a switch and a GPU-GPU bridge that enables multiple graphics processors 1500 (e.g., 8) to be interlinked without glue to each other with load/store units (LSUs), data transfer units, and sync semantics across multiple graphics processors 1500. In at least one embodiment, interconnects include standardized interconnects (e.g., PCIe) or some combination thereof.

In at least one embodiment, graphics core 1500 includes multiple tiles. In at least one embodiment, a tile is an individual die or one or more dies, where individual dies can be connected with an interconnect (e.g., embedded multi-die interconnect bridge (EMIB)). In at least one embodiment, graphics core 1500 includes a compute tile, a memory tile (e.g., where a memory tile can be exclusively accessed by different tiles or different chipsets such as a Rambo tile), substrate tile, a base tile, a HMB tile, a link tile, and EMIB tile, where all tiles are packaged together in graphics core 1500 as part of a GPU. In at least one embodiment, graphics core 1500 can include multiple tiles in a single package (also referred to as a “multi tile package”). In at least one embodiment, a compute tile can have 8 graphics cores 1500, an L1 cache; and a base tile can have a host interface with PCIe 5.0, HBM2e, MDFI, and EMIB, a link tile with 8 links, 8 ports with an embedded switch. In at least one embodiment, tiles are connected with face-to-face (F2F) chip-on-chip bonding through fine-pitched, 36-micron, microbumps (e.g., copper pillars). In at least one embodiment, graphics core 1500 includes memory fabric, which includes memory, and is tile that is accessible by multiple tiles. In at least one embodiment, graphics core 1500 stores, accesses, or loads its own hardware contexts in memory, where a hardware context is a set of data loaded from registers before a process resumes, and where a hardware context can indicate a state of hardware (e.g., state of a GPU).

In at least one embodiment, graphics core 1500 includes serializer/deserializer (SERDES) circuitry that converts a serial data stream to a parallel data stream, or converts a parallel data stream to a serial data stream.

In at least one embodiment, graphics core 1500 includes a high speed coherent unified fabric (GPU to GPU), load/store units, bulk data transfer and sync semantics, and connected GPUs through an embedded switch, where a GPU-GPU bridge is controlled by a controller.

In at least one embodiment, graphics core 1500 performs an API, where said API abstracts hardware of graphics core 1500 and access libraries with instructions to perform math operations (e.g., math kernel library), deep neural network operations (e.g., deep neural network library), vector operations, collective communications, thread building blocks, video processing, data analytics library, and/or ray tracing operations.

Embodiments presented herein can allow for a linear regulator with one or more features for improving the PSRR to identify and correct voltage noise within a circuit.

FIG. 15B illustrates a general-purpose processing unit (GPGPU) 1530 that can be configured to enable highly-parallel compute operations to be performed by an array of graphics processing units, in at least one embodiment. In at least one embodiment, GPGPU 1530 can be linked directly to other instances of GPGPU 1530 to create a multi-GPU cluster to improve training speed for deep neural networks. In at least one embodiment, GPGPU 1530 includes a host interface 1532 to enable a connection with a host processor. In at least one embodiment, host interface 1532 is a PCI Express interface. In at least one embodiment, host interface 1532 can be a vendor-specific communications interface or communications fabric. In at least one embodiment, GPGPU 1530 receives commands from a host processor and uses a global scheduler 1534 (which may be referred to as a thread sequencer and/or asynchronous compute engine) to distribute execution threads associated with those commands to a set of compute clusters 1536A-1536H. In at least one embodiment, compute clusters 1536A-1536H share a cache memory 1538. In at least one embodiment, cache memory 1538 can serve as a higher-level cache for cache memories within compute clusters 1536A-1536H.

In at least one embodiment, GPGPU 1530 includes memory 1544A-1544B coupled with compute clusters 1536A-1536H via a set of memory controllers 1542A-1542B (e.g., one or more controllers for HBM2e). In at least one embodiment, memory 1544A-1544B can include various types of memory devices including dynamic random access memory (DRAM) or graphics random access memory, such as synchronous graphics random access memory (SGRAM), including graphics double data rate (GDDR) memory.

In at least one embodiment, compute clusters 1536A-1536H each include a set of graphics cores, such as graphics core 1500 of FIG. 15A, which can include multiple types of integer and floating point logic units that can perform computational operations at a range of precisions including suited for machine learning computations. For example, in at least one embodiment, at least a subset of floating point units in each of compute clusters 1536A-1536H can be configured to perform 15-bit or 32-bit floating point operations, while a different subset of floating point units can be configured to perform 64-bit floating point operations.

In at least one embodiment, multiple instances of GPGPU 1530 can be configured to operate as a compute cluster. In at least one embodiment, communication used by compute clusters 1536A-1536H for synchronization and data exchange varies across embodiments. In at least one embodiment, multiple instances of GPGPU 1530 communicate over host interface 1532. In at least one embodiment, GPGPU 1530 includes an I/O hub 1539 that couples GPGPU 1530 with a GPU link 1540 that enables a direct connection to other instances of GPGPU 1530. In at least one embodiment, GPU link 1540 is coupled to a dedicated GPU-to-GPU bridge that enables communication and synchronization between multiple instances of GPGPU 1530. In at least one embodiment, GPU link 1540 couples with a high-speed interconnect to transmit and receive data to other GPGPUs or parallel processors. In at least one embodiment, multiple instances of GPGPU 1530 are located in separate data processing systems and communicate via a network device that is accessible via host interface 1532. In at least one embodiment GPU link 1540 can be configured to enable a connection to a host processor in addition to or as an alternative to host interface 1532.

In at least one embodiment, GPGPU 1530 can be configured to train neural networks. In at least one embodiment, GPGPU 1530 can be used within an inferencing platform. In at least one embodiment, in which GPGPU 1530 is used for inferencing, GPGPU 1530 may include fewer compute clusters 1536A-1536H relative to when GPGPU 1530 is used for training a neural network. In at least one embodiment, memory technology associated with memory 1544A-1544B may differ between inferencing and training configurations, with higher bandwidth memory technologies devoted to training configurations. In at least one embodiment, an inferencing configuration of GPGPU 1530 can support inferencing specific instructions. For example, in at least one embodiment, an inferencing configuration can provide support for one or more 8-bit integer dot product instructions, which may be used during inferencing operations for deployed neural networks.

Inference and/or training logic 815 are used to perform inferencing and/or training operations associated with one or more embodiments. In at least one embodiment, inference and/or training logic 815 may be used in GPGPU 1530 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

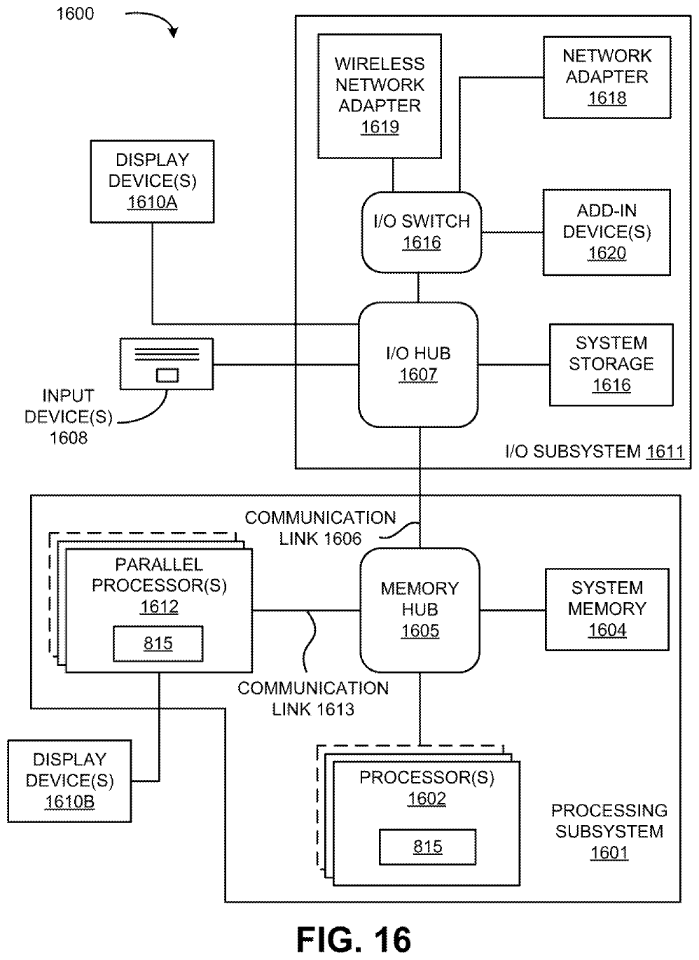

FIG. 16 is a block diagram illustrating a computing system 1600 according to at least one embodiment. In at least one embodiment, computing system 1600 includes a processing subsystem 1601 having one or more processor(s) 1602 and a system memory 1604 communicating via an interconnection path that may include a memory hub 1605. In at least one embodiment, memory hub 1605 may be a separate component within a chipset component or may be integrated within one or more processor(s) 1602. In at least one embodiment, memory hub 1605 couples with an I/O subsystem 1611 via a communication link 1606. In at least one embodiment, I/O subsystem 1611 includes an I/O hub 1607 that can enable computing system 1600 to receive input from one or more input device(s) 1608. In at least one embodiment, I/O hub 1607 can enable a display controller, which may be included in one or more processor(s) 1602, to provide outputs to one or more display device(s) 1610A. In at least one embodiment, one or more display device(s) 1610A coupled with I/O hub 1607 can include a local, internal, or embedded display device.

In at least one embodiment, processing subsystem 1601 includes one or more parallel processor(s) 1612 coupled to memory hub 1605 via a bus or other communication link 1613. In at least one embodiment, communication link 1613 may use one of any number of standards based communication link technologies or protocols, such as but not limited to PCI Express, or may be a vendor-specific communications interface or communications fabric. In at least one embodiment, one or more parallel processor(s) 1612 form a computationally focused parallel or vector processing system that can include a large number of processing cores and/or processing clusters, such as a many-integrated core (MIC) processor. In at least one embodiment, some or all of parallel processor(s) 1612 form a graphics processing subsystem that can output pixels to one of one or more display device(s) 1610A coupled via I/O hub 1607. In at least one embodiment, parallel processor(s) 1612 can also include a display controller and display interface (not shown) to enable a direct connection to one or more display device(s) 1610B. In at least one embodiment, parallel processor(s) 1612 include one or more cores, such as graphics cores 1500 discussed herein.

In at least one embodiment, a system storage unit 1614 can connect to I/O hub 1607 to provide a storage mechanism for computing system 1600. In at least one embodiment, an I/O switch 1616 can be used to provide an interface mechanism to enable connections between I/O hub 1607 and other components, such as a network adapter 1618 and/or a wireless network adapter 1619 that may be integrated into platform, and various other devices that can be added via one or more add-in device(s) 1620. In at least one embodiment, network adapter 1618 can be an Ethernet adapter or another wired network adapter. In at least one embodiment, wireless network adapter 1619 can include one or more of a Wi-Fi, Bluetooth, near field communication (NFC), or other network device that includes one or more wireless radios.

In at least one embodiment, computing system 1600 can include other components not explicitly shown, including USB or other port connections, optical storage drives, video capture devices, and like, may also be connected to I/O hub 1607. In at least one embodiment, communication paths interconnecting various components in FIG. 16 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1612 incorporate circuitry optimized for graphics and video processing, including, for example, video output circuitry, and constitutes a graphics processing unit (GPU), e.g., parallel processor(s) 1612 includes graphics core 1500. In at least one embodiment, parallel processor(s) 1612 incorporate circuitry optimized for general purpose processing. In at least embodiment, components of computing system 1600 may be integrated with one or more other system elements on a single integrated circuit. For example, in at least one embodiment, parallel processor(s) 1612, memory hub 1605, processor(s) 1602, and I/O hub 1607 can be integrated into a system on chip (SoC) integrated circuit. In at least one embodiment, components of computing system 1600 can be integrated into a single package to form a system in package (SIP) configuration. In at least one embodiment, at least a portion of components of computing system 1600 can be integrated into a multi-chip module (MCM), which can be interconnected with other multi-chip modules into a modular computing system.

Inference and/or training logic 815 are used to perform inferencing and/or training operations associated with one or more embodiments. In at least one embodiment, inference and/or training logic 815 may be used in system FIG. 16 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

### Processors

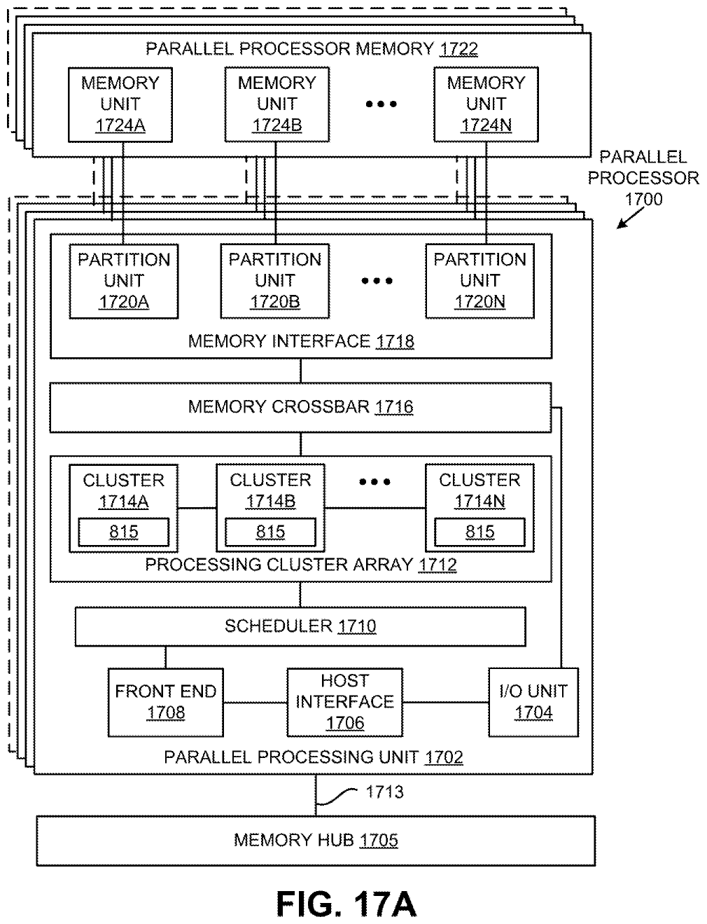

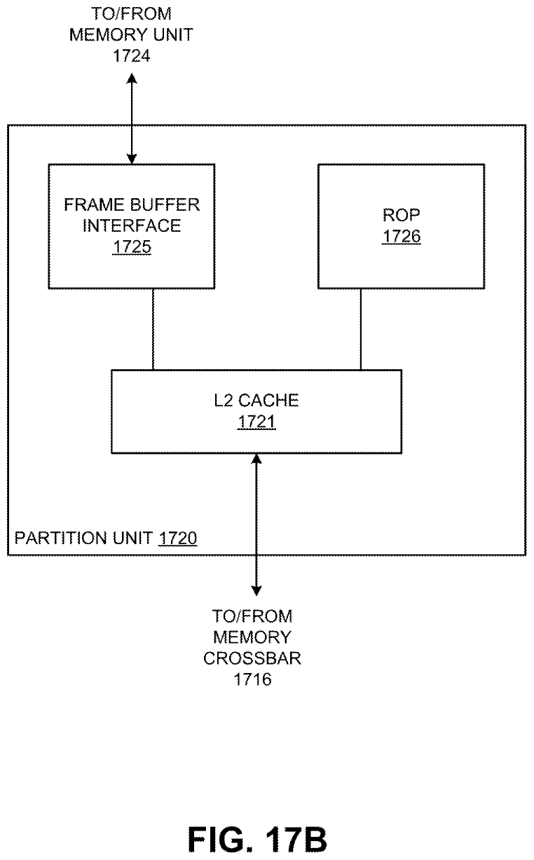

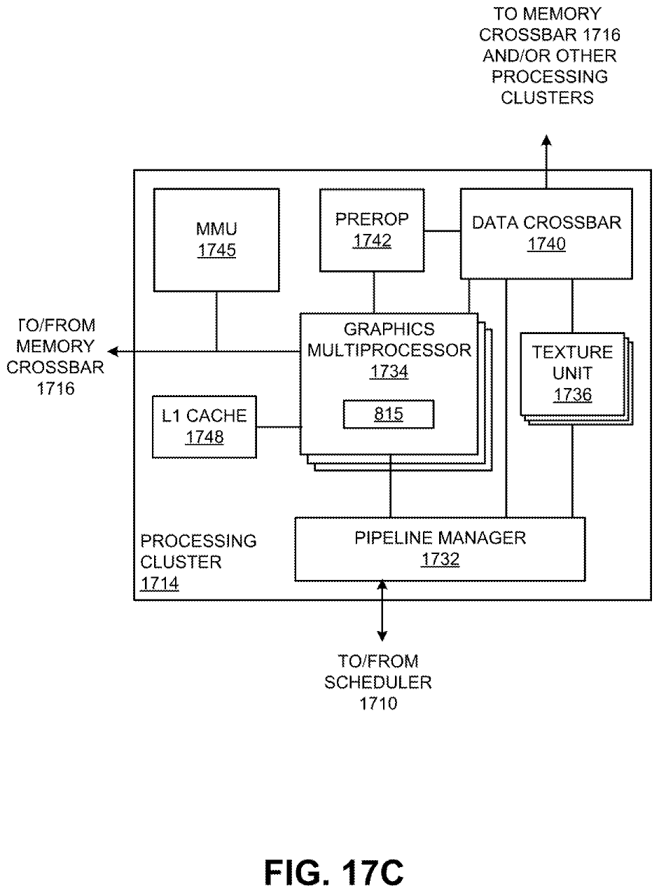

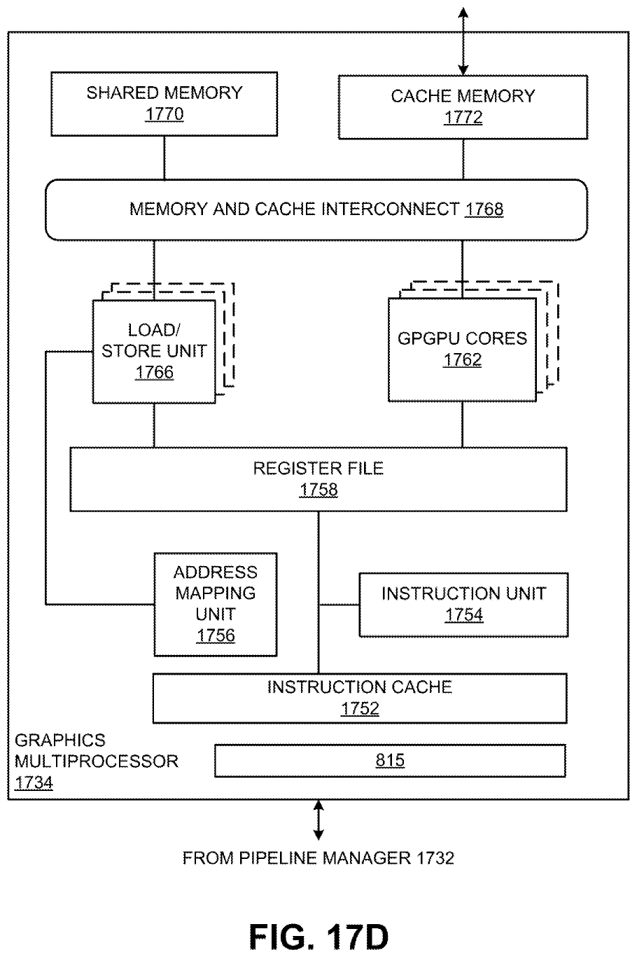

FIG. 17A illustrates a parallel processor 1700 according to at least one embodiment. In at least one embodiment, various components of parallel processor 1700 may be implemented using one or more integrated circuit devices, such as programmable processors, application specific integrated circuits (ASICs), or field programmable gate arrays (FPGA). In at least one embodiment, illustrated parallel processor 1700 is a variant of one or more parallel processor(s) 1612 shown in FIG. 16 according to an exemplary embodiment. In at least one embodiment, a parallel processor 1700 includes one or more graphics cores 1500.

In at least one embodiment, parallel processor 1700 includes a parallel processing unit 1702. In at least one embodiment, parallel processing unit 1702 includes an I/O unit 1704 that enables communication with other devices, including other instances of parallel processing unit 1702. In at least one embodiment, I/O unit 1704 may be directly connected to other devices. In at least one embodiment, I/O unit 1704 connects with other devices via use of a hub or switch interface, such as a memory hub 1705. In at least one embodiment, connections between memory hub 1705 and I/O unit 1704 form a communication link 1713. In at least one embodiment, I/O unit 1704 connects with a host interface 1706 and a memory crossbar 1716, where host interface 1706 receives commands directed to performing processing operations and memory crossbar 1716 receives commands directed to performing memory operations.

In at least one embodiment, when host interface 1706 receives a command buffer via I/O unit 1704, host interface 1706 can direct work operations to perform those commands to a front end 1708. In at least one embodiment, front end 1708 couples with a scheduler 1710 (which may be referred to as a sequencer), which is configured to distribute commands or other work items to a processing cluster array 1712. In at least one embodiment, scheduler 1710 ensures that processing cluster array 1712 is properly configured and in a valid state before tasks are distributed to a cluster of processing cluster array 1712. In at least one embodiment, scheduler 1710 is implemented via firmware logic executing on a microcontroller. In at least one embodiment, microcontroller implemented scheduler 1710 is configurable to perform complex scheduling and work distribution operations at coarse and fine granularity, enabling rapid preemption and context switching of threads executing on processing array 1712. In at least one embodiment, host software can prove workloads for scheduling on processing cluster array 1712 via one of multiple graphics processing paths. In at least one embodiment, workloads can then be automatically distributed across processing array cluster 1712 by scheduler 1710 logic within a microcontroller including scheduler 1710.

In at least one embodiment, processing cluster array 1712 can include up to “N” processing clusters (e.g., cluster 1714A, cluster 1714B, through cluster 1714N), where “N” represents a positive integer (which may be a different integer “N” than used in other figures). In at least one embodiment, each cluster 1714A-1714N of processing cluster array 1712 can execute a large number of concurrent threads. In at least one embodiment, scheduler 1710 can allocate work to clusters 1714A-1714N of processing cluster array 1712 using various scheduling and/or work distribution algorithms, which may vary depending on workload arising for each type of program or computation. In at least one embodiment, scheduling can be handled dynamically by scheduler 1710, or can be assisted in part by compiler logic during compilation of program logic configured for execution by processing cluster array 1712. In at least one embodiment, different clusters 1714A-1714N of processing cluster array 1712 can be allocated for processing different types of programs or for performing different types of computations.

In at least one embodiment, processing cluster array 1712 can be configured to perform various types of parallel processing operations. In at least one embodiment, processing cluster array 1712 is configured to perform general-purpose parallel compute operations. For example, in at least one embodiment, processing cluster array 1712 can include logic to execute processing tasks including filtering of video and/or audio data, performing modeling operations, including physics operations, and performing data transformations.

In at least one embodiment, processing cluster array 1712 is configured to perform parallel graphics processing operations. In at least one embodiment, processing cluster array 1712 can include additional logic to support execution of such graphics processing operations, including but not limited to, texture sampling logic to perform texture operations, as well as tessellation logic and other vertex processing logic. In at least one embodiment, processing cluster array 1712 can be configured to execute graphics processing related shader programs such as but not limited to, vertex shaders, tessellation shaders, geometry shaders, and pixel shaders. In at least one embodiment, parallel processing unit 1702 can transfer data from system memory via I/O unit 1704 for processing. In at least one embodiment, during processing, transferred data can be stored to on-chip memory (e.g., parallel processor memory 1722) during processing, then written back to system memory.

In at least one embodiment, when parallel processing unit 1702 is used to perform graphics processing, scheduler 1710 can be configured to divide a processing workload into approximately equal sized tasks, to better enable distribution of graphics processing operations to multiple clusters 1714A-1714N of processing cluster array 1712. In at least one embodiment, portions of processing cluster array 1712 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1714A-1714N may be stored in buffers to allow intermediate data to be transmitted between clusters 1714A-1714N for further processing.

In at least one embodiment, processing cluster array 1712 can receive processing tasks to be executed via scheduler 1710, which receives commands defining processing tasks from front end 1708. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1710 may be configured to fetch indices corresponding to tasks or may receive indices from front end 1708. In at least one embodiment, front end 1708 can be configured to ensure processing cluster array 1712 is configured to a valid state before a workload specified by incoming command buffers (e.g., batch-buffers, push buffers, etc.) is initiated.

In at least one embodiment, each of one or more instances of parallel processing unit 1702 can couple with a parallel processor memory 1722. In at least one embodiment, parallel processor memory 1722 can be accessed via memory crossbar 1716, which can receive memory requests from processing cluster array 1712 as well as I/O unit 1704. In at least one embodiment, memory crossbar 1716 can access parallel processor memory 1722 via a memory interface 1718. In at least one embodiment, memory interface 1718 can include multiple partition units (e.g., partition unit 1720A, partition unit 1720B, through partition unit 1720N) that can each couple to a portion (e.g., memory unit) of parallel processor memory 1722. In at least one embodiment, a number of partition units 1720A-1720N is configured to be equal to a number of memory units, such that a first partition unit 1720A has a corresponding first memory unit 1724A, a second partition unit 1720B has a corresponding memory unit 1724B, and an N-th partition unit 1720N has a corresponding N-th memory unit 1724N. In at least one embodiment, a number of partition units 1720A-1720N may not be equal to a number of memory units.

In at least one embodiment, memory units 1724A-1724N can include various types of memory devices, including dynamic random access memory (DRAM) or graphics random access memory, such as synchronous graphics random access memory (SGRAM), including graphics double data rate (GDDR) memory. In at least one embodiment, memory units 1724A-1724N may also include 3D stacked memory, including but not limited to high bandwidth memory (HBM), HBM2e, or HDM3. In at least one embodiment, render targets, such as frame buffers or texture maps may be stored across memory units 1724A-1724N, allowing partition units 1720A-1720N to write portions of each render target in parallel to efficiently use available bandwidth of parallel processor memory 1722. In at least one embodiment, a local instance of parallel processor memory 1722 may be excluded in favor of a unified memory design that utilizes system memory in conjunction with local cache memory.

In at least one embodiment, any one of clusters 1714A-1714N of processing cluster array 1712 can process data that will be written to any of memory units 1724A-1724N within parallel processor memory 1722. In at least one embodiment, memory crossbar 1716 can be configured to transfer an output of each cluster 1714A-1714N to any partition unit 1720A-1720N or to another cluster 1714A-1714N, which can perform additional processing operations on an output. In at least one embodiment, each cluster 1714A-1714N can communicate with memory interface 1718 through memory crossbar 1716 to read from or write to various external memory devices. In at least one embodiment, memory crossbar 1716 has a connection to memory interface 1718 to communicate with I/O unit 1704, as well as a connection to a local instance of parallel processor memory 1722, enabling processing units within different processing clusters 1714A-1714N to communicate with system memory or other memory that is not local to parallel processing unit 1702. In at least one embodiment, memory crossbar 1716 can use virtual channels to separate traffic streams between clusters 1714A-1714N and partition units 1720A-1720N.

In at least one embodiment, multiple instances of parallel processing unit 1702 can be provided on a single add-in card, or multiple add-in cards can be interconnected. In at least one embodiment, different instances of parallel processing unit 1702 can be configured to interoperate even if different instances have different numbers of processing cores, different amounts of local parallel processor memory, and/or other configuration differences. For example, in at least one embodiment, some instances of parallel processing unit 1702 can include higher precision floating point units relative to other instances. In at least one embodiment, systems incorporating one or more instances of parallel processing unit 1702 or parallel processor 1700 can be implemented in a variety of configurations and form factors, including but not limited to desktop, laptop, or handheld personal computers, servers, workstations, game consoles, and/or embedded systems.

FIG. 17B is a block diagram of a partition unit 1720 according to at least one embodiment. In at least one embodiment, partition unit 1720 is an instance of one of partition units 1720A-1720N of FIG. 17A. In at least one embodiment, partition unit 1720 includes an L2 cache 1721, a frame buffer interface 1725, and a ROP 1726 (raster operations unit). In at least one embodiment, L2 cache 1721 is a read/write cache that is configured to perform load and store operations received from memory crossbar 1716 and ROP 1726. In at least one embodiment, read misses and urgent write-back requests are output by L2 cache 1721 to frame buffer interface 1725 for processing. In at least one embodiment, updates can also be sent to a frame buffer via frame buffer interface 1725 for processing. In at least one embodiment, frame buffer interface 1725 interfaces with one of memory units in parallel processor memory, such as memory units 1724A-1724N of FIG. 17A (e.g., within parallel processor memory 1722).

In at least one embodiment, ROP 1726 is a processing unit that performs raster operations such as stencil, z test, blending, etc. In at least one embodiment, ROP 1726 then outputs processed graphics data that is stored in graphics memory. In at least one embodiment, ROP 1726 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1726 can vary based on statistical characteristics of data to be compressed. For example, in at least one embodiment, delta color compression is performed on depth and color data on a per-tile basis.

In at least one embodiment, ROP 1726 is included within each processing cluster (e.g., cluster 1714A-1714N of FIG. 17A) instead of within partition unit 1720. In at least one embodiment, read and write requests for pixel data are transmitted over memory crossbar 1716 instead of pixel fragment data. In at least one embodiment, processed graphics data may be displayed on a display device, such as one of one or more display device(s) 1610 of FIG. 16, routed for further processing by processor(s) 1602, or routed for further processing by one of processing entities within parallel processor 1700 of FIG. 17A.

FIG. 17C is a block diagram of a processing cluster 1714 within a parallel processing unit according to at least one embodiment. In at least one embodiment, a processing cluster is an instance of one of processing clusters 1714A-1714N of FIG. 17A. In at least one embodiment, processing cluster 1714 can be configured to execute many threads in parallel, where “thread” refers to an instance of a particular program executing on a particular set of input data. In at least one embodiment, single-instruction, multiple-data (SIMD) instruction issue techniques are used to support parallel execution of a large number of threads without providing multiple independent instruction units. In at least one embodiment, single-instruction, multiple-thread (SIMT) techniques are used to support parallel execution of a large number of generally synchronized threads, using a common instruction unit configured to issue instructions to a set of processing engines within each one of processing clusters.

In at least one embodiment, operation of processing cluster 1714 can be controlled via a pipeline manager 1732 that distributes processing tasks to SIMT parallel processors. In at least one embodiment, pipeline manager 1732 receives instructions from scheduler 1710 of FIG. 17A and manages execution of those instructions via a graphics multiprocessor 1734 and/or a texture unit 1736. In at least one embodiment, graphics multiprocessor 1734 is an exemplary instance of a SIMT parallel processor. However, in at least one embodiment, various types of SIMT parallel processors of differing architectures may be included within processing cluster 1714. In at least one embodiment, one or more instances of graphics multiprocessor 1734 can be included within a processing cluster 1714. In at least one embodiment, graphics multiprocessor 1734 can process data and a data crossbar 1740 can be used to distribute processed data to one of multiple possible destinations, including other shader units. In at least one embodiment, pipeline manager 1732 can facilitate distribution of processed data by specifying destinations for processed data to be distributed via data crossbar 1740.

In at least one embodiment, each graphics multiprocessor 1734 within processing cluster 1714 can include an identical set of functional execution logic (e.g., arithmetic logic units, load-store units, etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 1714 constitute a thread. In at least one embodiment, a set of threads executing across a set of parallel processing engines is a thread group. In at least one embodiment, a thread group executes a common program on different input data. In at least one embodiment, each thread within a thread group can be assigned to a different processing engine within a graphics multiprocessor 1734. In at least one embodiment, a thread group may include fewer threads than a number of processing engines within graphics multiprocessor 1734. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 1734. In at least one embodiment, when a thread group includes more threads than number of processing engines within graphics multiprocessor 1734, processing can be performed over consecutive clock cycles. In at least one embodiment, multiple thread groups can be executed concurrently on a graphics multiprocessor 1734.

In at least one embodiment, graphics multiprocessor 1734 includes an internal cache memory to perform load and store operations. In at least one embodiment, graphics multiprocessor 1734 can forego an internal cache and use a cache memory (e.g., L1 cache 1748) within processing cluster 1714. In at least one embodiment, each graphics multiprocessor 1734 also has access to L2 caches within partition units (e.g., partition units 1720A-1720N of FIG. 17A) that are shared among all processing clusters 1714 and may be used to transfer data between threads. In at least one embodiment, graphics multiprocessor 1734 may also access off-chip global memory, which can include one or more of local parallel processor memory and/or system memory. In at least one embodiment, any memory external to parallel processing unit 1702 may be used as global memory. In at least one embodiment, processing cluster 1714 includes multiple instances of graphics multiprocessor 1734 and can share common instructions and data, which may be stored in L1 cache 1748.

In at least one embodiment, each processing cluster 1714 may include an MMU 1745 (memory management unit) that is configured to map virtual addresses into physical addresses. In at least one embodiment, one or more instances of MMU 1745 may reside within memory interface 1718 of FIG. 17A. In at least one embodiment, MMU 1745 includes a set of page table entries (PTEs) used to map a virtual address to a physical address of a tile and optionally a cache line index. In at least one embodiment, MMU 1745 may include address translation lookaside buffers (TLB) or caches that may reside within graphics multiprocessor 1734 or L1 1748 cache or processing cluster 1714. In at least one embodiment, a physical address is processed to distribute surface data access locally to allow for efficient request interleaving among partition units. In at least one embodiment, a cache line index may be used to determine whether a request for a cache line is a hit or miss.

In at least one embodiment, a processing cluster 1714 may be configured such that each graphics multiprocessor 1734 is coupled to a texture unit 1736 for performing texture mapping operations, e.g., determining texture sample positions, reading texture data, and filtering texture data. In at least one embodiment, texture data is read from an internal texture L1 cache (not shown) or from an L1 cache within graphics multiprocessor 1734 and is fetched from an L2 cache, local parallel processor memory, or system memory, as needed. In at least one embodiment, each graphics multiprocessor 1734 outputs processed tasks to data crossbar 1740 to provide processed task to another processing cluster 1714 for further processing or to store processed task in an L2 cache, local parallel processor memory, or system memory via memory crossbar 1716. In at least one embodiment, a preROP 1742 (pre-raster operations unit) is configured to receive data from graphics multiprocessor 1734, and direct data to ROP units, which may be located with partition units as described herein (e.g., partition units 1720A-1720N of FIG. 17A). In at least one embodiment, preROP 1742 unit can perform optimizations for color blending, organizing pixel color data, and performing address translations.

Inference and/or training logic 815 are used to perform inferencing and/or training operations associated with one or more embodiments. In at least one embodiment, inference and/or training logic 815 may be used in graphics processing cluster 1714 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

FIG. 17D shows a graphics multiprocessor 1734 according to at least one embodiment. In at least one embodiment, graphics multiprocessor 1734 couples with pipeline manager 1732 of processing cluster 1714. In at least one embodiment, graphics multiprocessor 1734 has an execution pipeline including but not limited to an instruction cache 1752, an instruction unit 1754, an address mapping unit 1756, a register file 1758, one or more general purpose graphics processing unit (GPGPU) cores 1762, and one or more load/store units 1766, where one or more load/store units 1766 can perform load/store operations to load/store instructions corresponding to performing an operation. In at least one embodiment, GPGPU cores 1762 and load/store units 1766 are coupled with cache memory 1772 and shared memory 1770 via a memory and cache interconnect 1768.

In at least one embodiment, instruction cache 1752 receives a stream of instructions to execute from pipeline manager 1732. In at least one embodiment, instructions are cached in instruction cache 1752 and dispatched for execution by an instruction unit 1754. In at least one embodiment, instruction unit 1754 can dispatch instructions as thread groups (e.g., warps, wavefronts, waves), with each thread of thread group assigned to a different execution unit within GPGPU cores 1762. In at least one embodiment, an instruction can access any of a local, shared, or global address space by specifying an address within a unified address space. In at least one embodiment, address mapping unit 1756 can be used to translate addresses in a unified address space into a distinct memory address that can be accessed by load/store units 1766.

In at least one embodiment, register file 1758 provides a set of registers for functional units of graphics multiprocessor 1734. In at least one embodiment, register file 1758 provides temporary storage for operands connected to data paths of functional units (e.g., GPGPU cores 1762, load/store units 1766) of graphics multiprocessor 1734. In at least one embodiment, register file 1758 is divided between each of functional units such that each functional unit is allocated a dedicated portion of register file 1758. In at least one embodiment, register file 1758 is divided between different warps (which may be referred to as wavefronts and/or waves) being executed by graphics multiprocessor 1734.

In at least one embodiment, GPGPU cores 1762 can each include floating point units (FPUs) and/or integer arithmetic logic units (ALUs) that are used to execute instructions of graphics multiprocessor 1734. In at least one embodiment, GPGPU cores 1762 can be similar in architecture or can differ in architecture. In at least one embodiment, a first portion of GPGPU cores 1762 include a single precision FPU and an integer ALU while a second portion of GPGPU cores include a double precision FPU. In at least one embodiment, FPUs can implement IEEE 754-2008 standard floating point arithmetic or enable variable precision floating point arithmetic. In at least one embodiment, graphics multiprocessor 1734 can additionally include one or more fixed function or special function units to perform specific functions such as copy rectangle or pixel blending operations. In at least one embodiment, one or more of GPGPU cores 1762 can also include fixed or special function logic.

In at least one embodiment, GPGPU cores 1762 include SIMD logic capable of performing a single instruction on multiple sets of data. In at least one embodiment, GPGPU cores 1762 can physically execute SIMD4, SIMD8, and SIMD16 instructions and logically execute SIMD1, SIMD2, and SIMD32 instructions. In at least one embodiment, SIMD instructions for GPGPU cores can be generated at compile time by a shader compiler or automatically generated when executing programs written and compiled for single program multiple data (SPMD) or SIMT architectures. In at least one embodiment, multiple threads of a program configured for an SIMT execution model can executed via a single SIMD instruction. For example, in at least one embodiment, eight SIMT threads that perform same or similar operations can be executed in parallel via a single SIMD8 logic unit.

In at least one embodiment, memory, and cache interconnect 1768 is an interconnect network that connects each functional unit of graphics multiprocessor 1734 to register file 1758 and to shared memory 1770. In at least one embodiment, memory and cache interconnect 1768 is a crossbar interconnect that allows load/store units 1766 to implement load and store operations between shared memory 1770 and register file 1758. In at least one embodiment, register file 1758 can operate at a same frequency as GPGPU cores 1762, thus data transfer between GPGPU cores 1762 and register file 1758 can have very low latency. In at least one embodiment, shared memory 1770 can be used to enable communication between threads that execute on functional units within graphics multiprocessor 1734. In at least one embodiment, cache memory 1772 can be used as a data cache for example, to cache texture data communicated between functional units and texture unit 1736. In at least one embodiment, shared memory 1770 can also be used as a program managed cache. In at least one embodiment, threads executing on GPGPU cores 1762 can programmatically store data within shared memory in addition to automatically cached data that is stored within cache memory 1772.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high-speed interconnect such as PCIe or NVLink). In at least one embodiment, a GPU may be integrated on a package or chip as cores and communicatively coupled to cores over an internal processor bus/interconnect internal to a package or chip. In at least one embodiment, regardless a manner in which a GPU is connected, processor cores may allocate work to such GPU in a form of sequences of commands/instructions contained in a work descriptor. In at least one embodiment, that GPU then uses dedicated circuitry/logic for efficiently processing these commands/instructions.

Inference and/or training logic 815 are used to perform inferencing and/or training operations associated with one or more embodiments. In at least one embodiment, inference and/or training logic 815 may be used in graphics multiprocessor 1734 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

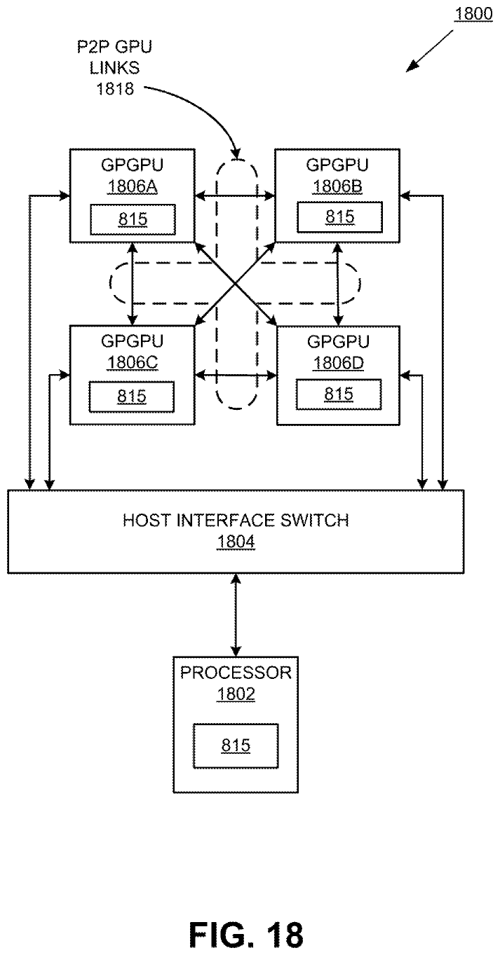

FIG. 18 illustrates a multi-GPU computing system 1800, according to at least one embodiment. In at least one embodiment, multi-GPU computing system 1800 can include a processor 1802 coupled to multiple general purpose graphics processing units (GPGPUs) 1806A-D via a host interface switch 1804. In at least one embodiment, host interface switch 1804 is a PCI express switch device that couples processor 1802 to a PCI express bus over which processor 1802 can communicate with GPGPUs 1806A-D. In at least one embodiment, GPGPUs 1806A-D can interconnect via a set of high-speed point-to-point GPU-to-GPU links 1816. In at least one embodiment, GPU-to-GPU links 1816 connect to each of GPGPUs 1806A-D via a dedicated GPU link. In at least one embodiment, P2P GPU links 1818 enable direct communication between each of GPGPUs 1806A-D without requiring communication over host interface bus 1804 to which processor 1802 is connected. In at least one embodiment, with GPU-to-GPU traffic directed to P2P GPU links 1818, host interface bus 1804 remains available for system memory access or to communicate with other instances of multi-GPU computing system 1800, for example, via one or more network devices. While in at least one embodiment GPGPUs 1806A-D connect to processor 1802 via host interface switch 1804, in at least one embodiment processor 1802 includes direct support for P2P GPU links 1818 and can connect directly to GPGPUs 1806A-D.

Inference and/or training logic 815 are used to perform inferencing and/or training operations associated with one or more embodiments. In at least one embodiment, inference and/or training logic 815 may be used in multi-GPU computing system 1800 for inferencing or predicting operations based, at least in part, on weight parameters calculated using neural network training operations, neural network functions and/or architectures, or neural network use cases described herein.

In at least one embodiment, multi-GPU computing system 1800 includes one or more graphics cores 1500.

Embodiments presented herein can allow for a linear regulator with one or more features for improving the PSRR to identify and correct voltage noise within a circuit.

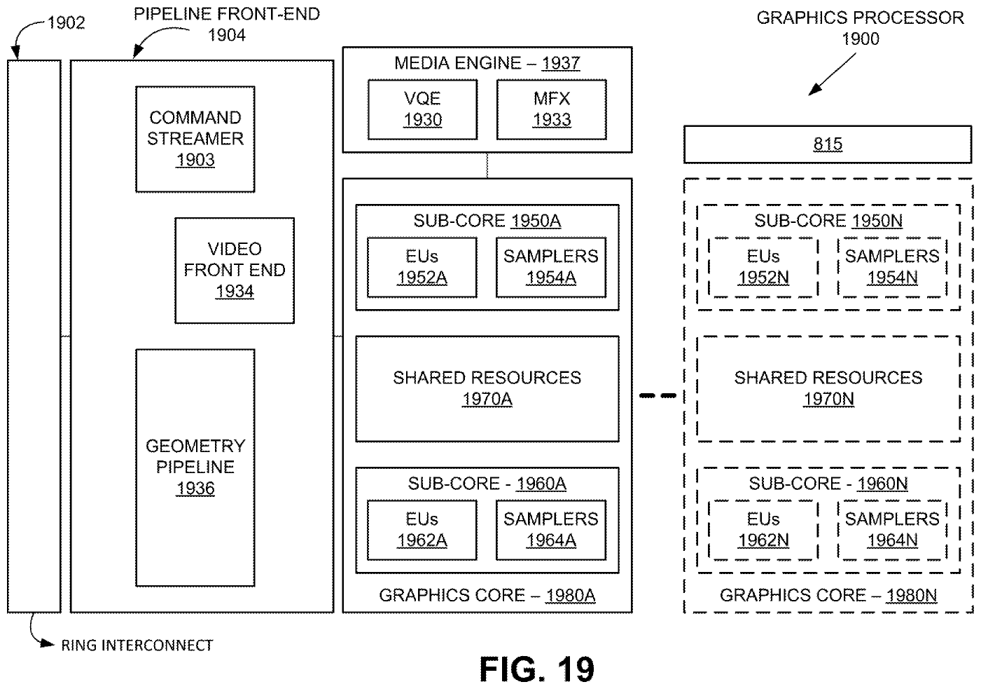

FIG. 19 is a block diagram of a graphics processor 1900, according to at least one embodiment. In at least one embodiment, graphics processor 1900 includes a ring interconnect 1902, a pipeline front-end 1904, a media engine 1937, and graphics cores 1980A-1980N. In at least one embodiment, ring interconnect 1902 couples graphics processor 1900 to other processing units, including other graphics processors or one or more general-purpose processor cores. In at least one embodiment, graphics processor 1900 is one of many processors integrated within a multi-core processing system. In at least one embodiment, graphics processor 1900 includes graphics core 1500.

In at least one embodiment, graphics processor 1900 receives batches of commands via ring interconnect 1902. In at least one embodiment, incoming commands are interpreted by a command streamer 1903 in pipeline front-end 1904. In at least one embodiment, graphics processor 1900 includes scalable execution logic to perform 3D geometry processing and media processing via graphics core(s) 1980A-1980N. In at least one embodiment, for 3D geometry processing commands, command streamer 1903 supplies commands to geometry pipeline 1936. In at least one embodiment, for at least some media processing commands, command streamer 1903 supplies commands to a video front end 1934, which couples with media engine 1937. In at least one embodiment, media engine 1937 includes a Video Quality Engine (VQE) 1930 for video and image post-processing and a multi-format encode/decode (MFX) 1933 engine to provide hardware-accelerated media data encoding and decoding. In at least one embodiment, geometry pipeline 1936 and media engine 1937 each generate execution threads for thread execution resources provided by at least one graphics core 1980.

In at least one embodiment, graphics processor 1900 includes scalable thread execution resources featuring graphics cores 1980A-1980N (which can be modular and are sometimes referred to as core slices), each having multiple sub-cores 1950A-50N, 1960A-1960N (sometimes referred to as core sub-slices). In at least one embodiment, graphics processor 1900 can have any number of graphics cores 1980A. In at least one embodiment, graphics processor 1900 includes a graphics core 1980A having at least a first sub-core 1950A and a second sub-core 1960A. In at least one embodiment, graphics processor 1900 is a low power processor with a single sub-core (e.g., 1950A). In at least one embodiment, graphics processor 1900 includes multiple graphics cores 1980A-1980N, each including a set of first sub-cores 1950A-1950N and a set of second sub-cores 1960A-1960N. In at least one embodiment, each sub-core in first sub-cores 1950A-1950N includes at least a first set of execution units 1952A-1952N and media/texture samplers 1954A-1954N. In at least one embodiment, each sub-core in second sub-cores 1960A-1960N includes at least a second set of execution units 1962A-1962N and samplers 1964A-1964N. In at least one embodiment, each sub-core 1950A-1950N, 1960A-1960N shares a set of shared resources 1970A-1970N. In at least one embodiment, shared resources include shared cache memory and pixel operation logic. In at least one embodiment, graphics processor 1900 includes load/store units in pipeline front-end 1904.

Inference and/or training logic 815 are used to perform inferencing and/or training operations associated with one or more embodiments. In at least one embodiment, inference and/or training logic 815 may be used in graphics processor 1900 for inferencing or predicting operations based, at least in part, on weight parameters calculated using neural network training operations, neural network functions and/or architectures, or neural network use cases described herein.

Embodiments presented herein can allow for a linear regulator with one or more features for improving the PSRR to identify and correct voltage noise within a circuit.

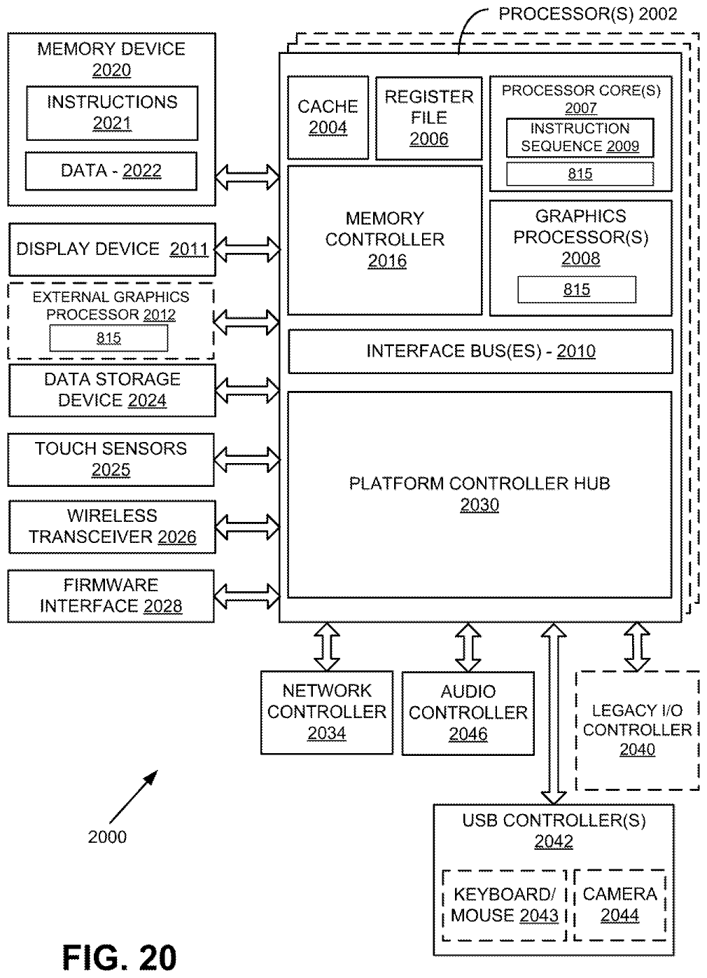

FIG. 20 is a block diagram of a processing system, according to at least one embodiment. In at least one embodiment, system 2000 includes one or more processor(s) 2002 and one or more graphics processor(s) 2008, and may be a single processor desktop system, a multiprocessor workstation system, or a server system having a large number of processor(s) 2002 or processor core(s) 2007. In at least one embodiment, system 2000 is a processing platform incorporated within a system-on-a-chip (SoC) integrated circuit for use in mobile, handheld, or embedded devices. In at least one embodiment, one or more graphics processor(s) 2008 include one or more graphics cores 1500.

In at least one embodiment, system 2000 can include, or be incorporated within a server-based gaming platform, a game console, including a game and media console, a mobile gaming console, a handheld game console, or an online game console. In at least one embodiment, system 2000 is a mobile phone, a smart phone, a tablet computing device or a mobile Internet device. In at least one embodiment, processing system 2000 can also include, couple with, or be integrated within a wearable device, such as a smart watch wearable device, a smart eyewear device, an augmented reality device, or a virtual reality device. In at least one embodiment, processing system 2000 is a television or set top box device having one or more processor(s) 2002 and a graphical interface generated by one or more graphics processor(s) 2008.

In at least one embodiment, one or more processor(s) 2002 each include one or more processor core(s) 2007 to process instructions which, when executed, perform operations for system and user software. In at least one embodiment, each of one or more processor core(s) 2007 is configured to process a specific instruction sequence 2009. In at least one embodiment, instruction sequence 2009 may facilitate Complex Instruction Set Computing (CISC), Reduced Instruction Set Computing (RISC), or computing via a Very Long Instruction Word (VLIW). In at least one embodiment, processor core(s) 2007 may each process a different instruction sequence 2009, which may include instructions to facilitate emulation of other instruction sequences. In at least one embodiment, processor core(s) 2007 may also include other processing devices, such a Digital Signal Processor (DSP).

In at least one embodiment, processor(s) 2002 includes a cache memory 2004. In at least one embodiment, processor(s) 2002 can have a single internal cache or multiple levels of internal cache. In at least one embodiment, cache memory is shared among various components of processor(s) 2002. In at least one embodiment, processor(s) 2002 also uses an external cache (e.g., a Level-3 (L3) cache or Last Level Cache (LLC)) (not shown), which may be shared among processor core(s) 2007 using known cache coherency techniques. In at least one embodiment, a register file 2006 is additionally included in processor(s) 2002, which may include different types of registers for storing different types of data (e.g., integer registers, floating point registers, status registers, and an instruction pointer register). In at least one embodiment, register file 2006 may include general-purpose registers or other registers.

In at least one embodiment, one or more processor(s) 2002 are coupled with one or more interface bus(es) 2010 to transmit communication signals such as address, data, or control signals between processor(s) 2002 and other components in system 2000. In at least one embodiment, interface bus(es) 2010 can be a processor bus, such as a version of a Direct Media Interface (DMI) bus. In at least one embodiment, interface bus(es) 2010 is not limited to a DMI bus, and may include one or more Peripheral Component Interconnect buses (e.g., PCI, PCI Express), memory busses, or other types of interface busses. In at least one embodiment processor(s) 2002 include an integrated memory controller 2016 and a platform controller hub 2030. In at least one embodiment, memory controller 2016 facilitates communication between a memory device and other components of system 2000, while platform controller hub (PCH) 2030 provides connections to I/O devices via a local I/O bus.

In at least one embodiment, a memory device 2020 can be a dynamic random access memory (DRAM) device, a static random access memory (SRAM) device, flash memory device, phase-change memory device, or some other memory device having suitable performance to serve as process memory. In at least one embodiment, memory device 2020 can operate as system memory for system 2000, to store data 2022 and instructions 2021 for use when one or more processor(s) 2002 executes an application or process. In at least one embodiment, memory controller 2016 also couples with an optional external graphics processor 2012, which may communicate with one or more graphics processor(s) 2008 in processor(s) 2002 to perform graphics and media operations. In at least one embodiment, a display device 2011 can connect to processor(s) 2002. In at least one embodiment, display device 2011 can include one or more of an internal display device, as in a mobile electronic device or a laptop device, or an external display device attached via a display interface (e.g., DisplayPort, etc.). In at least one embodiment, display device 2011 can include a head mounted display (HMD) such as a stereoscopic display device for use in virtual reality (VR) applications or augmented reality (AR) applications.

In at least one embodiment, platform controller hub 2030 enables peripherals to connect to memory device 2020 and processor(s) 2002 via a high-speed I/O bus. In at least one embodiment, I/O peripherals include, but are not limited to, an audio controller 2046, a network controller 2034, a firmware interface 2028, a wireless transceiver 2026, touch sensors 2025, a data storage device 2024 (e.g., hard disk drive, flash memory, etc.). In at least one embodiment, data storage device 2024 can connect via a storage interface (e.g., SATA) or via a peripheral bus, such as a Peripheral Component Interconnect bus (e.g., PCI, PCI Express). In at least one embodiment, touch sensors 2025 can include touch screen sensors, pressure sensors, or fingerprint sensors. In at least one embodiment, wireless transceiver 2026 can be a Wi-Fi transceiver, a Bluetooth transceiver, or a mobile network transceiver such as a 3G, 4G, or Long Term Evolution (LTE) transceiver. In at least one embodiment, firmware interface 2028 enables communication with system firmware, and can be, for example, a unified extensible firmware interface (UEFI). In at least one embodiment, network controller 2034 can enable a network connection to a wired network. In at least one embodiment, a high-performance network controller (not shown) couples with interface bus(es) 2010. In at least one embodiment, audio controller 2046 is a multi-channel high definition audio controller. In at least one embodiment, system 2000 includes an optional legacy I/O controller 2040 for coupling legacy (e.g., Personal System 2 (PS/2)) devices to system 2000. In at least one embodiment, platform controller hub 2030 can also connect to one or more Universal Serial Bus (USB) controller(s) 2042 connect input devices, such as keyboard and mouse 2043 combinations, a camera 2044, or other USB input devices.

In at least one embodiment, an instance of memory controller 2016 and platform controller hub 2030 may be integrated into a discreet external graphics processor, such as external graphics processor 2012. In at least one embodiment, platform controller hub 2030 and/or memory controller 2016 may be external to one or more processor(s) 2002. For example, in at least one embodiment, system 2000 can include an external memory controller 2016 and platform controller hub 2030, which may be configured as a memory controller hub and peripheral controller hub within a system chipset that is in communication with processor(s) 2002.

Embodiments presented herein can allow for a linear regulator with one or more features for improving the PSRR to identify and correct voltage noise within a circuit.

At least one embodiment of the disclosure can be described in view of the following clauses:
1. A method comprising:
regulating an input voltage, received to a linear regulator, as a regulated voltage;
receiving a ripple, identified in the regulated voltage, to a suppression element;
producing, using the suppression element, an opposite polarity ripple having increased gain;
applying the opposite polarity ripple at the regulated voltage to suppress the ripple; and
providing the output voltage from the linear regulator.
2. The method of clause 1, wherein producing the opposite polarity ripple further comprises:
sending the ripple through a first high pass filter;
amplifying and inverting the ripple;
adjusting a DC biasing of the ripple; and
sending the ripple through a second high pass filter.
3. The method of clause 1, wherein applying the opposite polarity ripple at the regulated voltage further comprises:
delivering the opposite polarity ripple using AC coupling.
4. The method of clause 1, wherein the suppression element receives the ripple as a portion of the regulated voltage frequency spectrum.
5. The method of clause 1, wherein the suppression element is connected to a portion of the pass device.
6. The method of clause 5, wherein the pass device is a NMOS pass device.
7. The method of clause 6, wherein the NMOS pass device is connected to the linear regulator and configured as a source follower.
8. The method of clause 1, wherein the suppression element includes three GM-GM inverter amplifiers.
9. The method of clause 1, wherein regulating the input voltage further comprises:
providing, using at least an error amplifier, a regulated voltage with the ripple from the input voltage;
suppressing, using at least a main loop of the linear regulator, a first portion of the ripple of the regulated voltage; and
suppressing, using at least a load capacitor, a second portion of the ripple of the regulated voltage.
10. The method of clause 9, wherein one or more frequencies of the ripple of the regulated voltage are higher than frequencies of the first portion and are lower than frequencies of the second portion.
11. A system, comprising:

one or more electrical components configured to:
regulate an input voltage, received to a linear regulator, as a regulated voltage;
   receive a ripple, identified in the regulated voltage, to a suppression element;
   produce, using the suppression element, an opposite polarity ripple having increased gain;
   apply the opposite polarity ripple at the regulated voltage to suppress the ripple; and
   provide the output voltage from the linear regulator.
12. The system of clause 11, wherein the one or more elements are further to:
send the ripple through a first high pass filter;
amplify and invert the ripple;
adjust a DC biasing of the ripple; and send the ripple through a second high pass filter.
13. The system of clause 11, wherein the suppression element receives the ripple as a portion of the regulated voltage frequency spectrum.
14. The system of clause 11, wherein the one or more elements are further to:
providing, using at least an error amplifier, a regulated voltage with the ripple from the input voltage;
suppressing, using at least a main loop of the linear regulator, a first portion of the ripple of the regulated voltage; and
suppressing, using at least a load capacitor, a second portion of the ripple of the regulated voltage.
15. The system of clause 14, wherein one or more frequencies of the identified ripple are greater than frequencies of the first portion and are less than frequencies of the second portion.
16. A low drop out linear regulator, comprising:
one or more circuit elements to perform ripple identification and modification of a voltage that is received from a voltage source, the ripple identification and modification to produce an opposite polarity ripple with additional gain, and supply the opposite polarity ripple to the voltage to modify the ripple.
17. The low drop out linear regulator of clause 16, wherein the opposite polarity ripple is further produced with a first high pass filter, one or more amplifier inverters, a low speed loop, and a second high pass filter.
18. The low drop out linear regulator of clause 16, wherein at least one of the circuit elements receive a portion of the voltage frequency spectrum.
19. The low drop out linear regulator of clause 16, wherein the voltage is further corrected using at least an error amplifier, a main loop, and a load capacitor.
20. The low drop out linear regulator of clause 16, wherein the low drop out linear regulator is comprised in at least one of:
a system for performing simulation operations;
a system for performing simulation operations to test or validate autonomous machine applications;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or a system implemented at least partially using cloud computing resources.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, referring back to FIG. 11, computer programs in form of machine-readable executable code or computer control logic algorithms are stored in main memory 1104 and/or secondary storage. Computer programs, if executed by one or more processors, enable computer system 1100 to perform various functions in accordance with at least one embodiment. In at least one embodiment, main memory 1104, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous FIGS. 1-7 are implemented in context of CPU 1102, parallel processing system 1112, an integrated circuit capable of at least a portion of capabilities of both CPU 1102, parallel processing system 1112, a chipset (e.g., a group of integrated circuits designed to work and sold as a unit for performing related functions, etc.), and/or any suitable combination of integrated circuit(s).

In at least one embodiment, architecture and/or functionality of various previous FIGS. 1-7 are implemented in context of a general computer system, a circuit board system, a game console system dedicated for entertainment purposes, an application-specific system, and more. In at least one embodiment, computer system 1100 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 1112 includes, without limitation, a plurality of parallel processing units (“PPUs”) 1114 and associated memories 1116. In at least one embodiment, PPUs 1114 are connected to a host processor or other peripheral devices via an interconnect 1118 and a switch 1120 or multiplexer. In at least one embodiment, parallel processing system 1112 distributes computational tasks across PPUs 1114 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 1114, although such shared memory may incur performance penalties relative to use of local memory and registers resident to a PPU 1114. In at least one embodiment, operation of PPUs 1114 is synchronized through use of a command such as syncthreads ( ) wherein all threads in a block (e.g., executed across multiple PPUs 1114) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, one VPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processor 1410, graphics processor 1440, graphics core 1500, parallel processor 1700, graphics processor 1900, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
regulating an input voltage, received to a linear regulator, as a regulated voltage;
receiving a ripple, identified in the regulated voltage, to a suppression element;
producing, using the suppression element, an opposite polarity ripple having increased gain;
applying the opposite polarity ripple at the regulated voltage to suppress the ripple; and
providing the output voltage from the linear regulator.

2. The method of claim 1, wherein producing the opposite polarity ripple further comprises:
sending the ripple through a first high pass filter;
amplifying and inverting the ripple;
adjusting a DC biasing of the ripple; and
sending the ripple through a second high pass filter.

3. The method of claim 1, wherein applying the opposite polarity ripple at the regulated voltage further comprises:
delivering the opposite polarity ripple using AC coupling.

4. The method of claim 1, wherein the suppression element receives the ripple as a portion of the regulated voltage frequency spectrum.

5. The method of claim 1, wherein the suppression element is connected to a portion of the pass device.

6. The method of claim 5, wherein the pass device is a NMOS pass device.

7. The method of claim 6, wherein the NMOS pass device is connected to the linear regulator and configured as a source follower.

8. The method of claim 1, wherein the suppression element includes three GM-GM inverter amplifiers.

9. The method of claim 1, wherein regulating the input voltage further comprises:
providing, using at least an error amplifier, a regulated voltage with the ripple from the 2 input voltage;
suppressing, using at least a main loop of the linear regulator, a first portion of the ripple of the regulated voltage; and
suppressing, using at least a load capacitor, a second portion of the ripple of the regulated voltage.

10. The method of claim 9, wherein one or more frequencies of the ripple of the regulated voltage are higher than frequencies of the first portion and are lower than frequencies of the second portion.

11. A system, comprising:
one or more electrical components configured to:
regulate an input voltage, received to a linear regulator, as a regulated voltage;
receive a ripple, identified in the regulated voltage, to a suppression element;
produce, using the suppression element, an opposite polarity ripple having increased gain;
apply the opposite polarity ripple at the regulated voltage to suppress the ripple; and
provide the output voltage from the linear regulator.

12. The system of claim 11, wherein the one or more elements are further to:
send the ripple through a first high pass filter;
amplify and invert the ripple;
adjust a DC biasing of the ripple; and
send the ripple through a second high pass filter.

13. The system of claim 11, wherein the suppression element receives the ripple as a portion of the regulated voltage frequency spectrum.

14. The system of claim 11, wherein the one or more elements are further to:
providing, using at least an error amplifier, a regulated voltage with the ripple from the input voltage;
suppressing, using at least a main loop of the linear regulator, a first portion of the ripple of the regulated voltage; and
suppressing, using at least a load capacitor, a second portion of the ripple of the regulated voltage.

15. The system of claim 14, wherein one or more frequencies of the identified ripple are greater than frequencies of the first portion and are less than frequencies of the second portion.

16. A low drop out linear regulator, comprising:
one or more circuit elements to perform ripple identification and modification of a voltage that is received from a voltage source, the ripple identification and modification to produce an opposite polarity ripple with additional gain, and supply the opposite polarity ripple to the voltage to modify the ripple.

17. The low drop out linear regulator of claim 16, wherein the opposite polarity ripple is further produced with a first high pass filter, one or more amplifier inverters, a low speed loop, and a second high pass filter.

18. The low drop out linear regulator of claim 16, wherein at least one of the circuit elements receive a portion of the voltage frequency spectrum.

19. The low drop out linear regulator of claim 16, wherein the voltage is further corrected using at least an error amplifier, a main loop, and a load capacitor.

20. The low drop out linear regulator of claim 16, wherein the low drop out linear regulator is comprised in at least one of:
a system for performing simulation operations;
a system for performing simulation operations to test or validate autonomous machine applications;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
